(19) United States
(12) Patent Application Publication
(10) Pub. No.: US 2026/0066322 A1
(43) Pub. Date: Mar. 5, 2026

(54) PROTON EXCHANGE MEMBRANE COMPRISING FREE RADICAL SCAVENGING POLYMER

(71) Applicant: UOP LLC, Des Plaines, IL (US)

(72) Inventors: Chunqing Liu, Arlington Heights, IL (US); Changqing Lu, Arlington Heights, IL (US); Nicholas Haxel, Mount Prospect, IL (US); Dennis F. van der Vliet, Skokie, IL (US)

(21) Appl. No.: 18/816,092

(22) Filed: Aug. 27, 2024

(51) Int. Cl. H01M 8/1027; H01M 8/10; H01M 8/1004; H01M 8/1032

(52) U.S. Cl. CPC H01M 8/1027; H01M 8/1004; H01M 8/1032; H01M 2008/1095

(57) ABSTRACT

Proton exchange membranes are described. The proton exchange membranes comprise a blend of a proton-conductive polymer and a free radical scavenging polymer having phenolic hydroxyl groups. The free radical scavenging polymer and the cation exchange polymer form a miscible polymer blend with no phase separation or inorganic particle agglomeration issues. The free radical scavenging polymer may comprise a plurality of repeating units of formula (II) having phenolic hydroxyl functional groups.

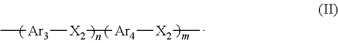

Membrane electrode assemblies incorporating the proton exchange membranes are also described.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline water electrolysis (AEL), proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

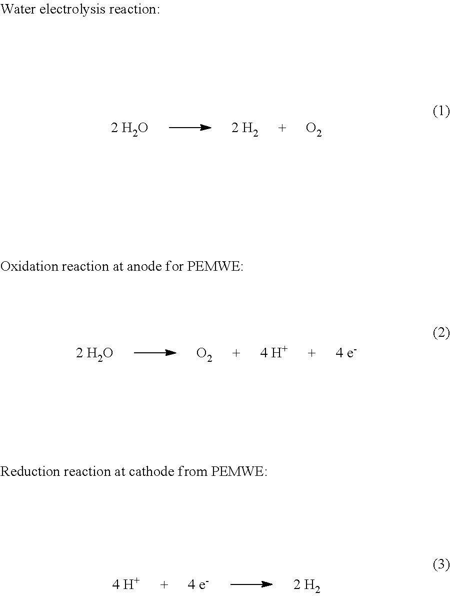

Fuel cells, as a next generation clean energy resource, convert the energy of chemical reactions such as an oxidation/reduction redox reaction of hydrogen and oxygen into electric energy. The three main types of fuel cells are alkaline electrolyte fuel cells, polymer electrolyte membrane fuel cells, and solid oxide fuel cells. Polymer electrolyte membrane fuel cells may include proton exchange membrane fuel cells (PEMFC), anion exchange membrane fuel cells (AEMFC), and direct methanol fuel cells. PEMFC uses a PEM to conduct protons from the anode to the cathode, and it also separates the H₂ and O₂ gases to prevent gas crossover. AEMFC uses an AEM to conduct OH⁻ from the cathode to the anode, and it also separates the H₂ and O₂ gases to prevent gas crossover.

The anode in an electrochemical cell is the electrode at which the predominant reaction is oxidation (e.g., the water oxidation/oxygen evolution reaction electrode for a water electrolyzer, or the hydrogen oxidation electrode for a fuel cell). The cathode in an electrochemical cell is the electrode at which the predominant reaction is reduction (e.g., the proton reduction/hydrogen evolution reaction electrode for a water electrolyzer, or the oxygen reduction electrode for a fuel cell).

Significant advances are needed in cost-effective, high performance, stable catalysts, membrane materials, as well as other cell stack components for electrolysis and fuel cells with a wide range of applications in renewable energy systems.

Redox flow batteries (RFBs) comprise two external storage tanks filled with active materials comprising metal ions that may be in different valance states, two circulation pumps, and a flow cell with a separation membrane and two electrodes. The separation membrane is located between the anode and the cathode and is used to separate the anolyte and the catholyte, as well as to utilize the current circuit by allowing the transfer of balancing ions. The anolyte, catholyte, anode, and cathode may also be referred to as plating electrolyte or negative electrolyte, redox electrolyte or positive electrolyte, plating electrode or negative electrode, and redox electrode or positive electrode respectively. Among all the redox flow batteries developed to date, all vanadium redox flow batteries (VRFB) have been the most extensively studied. VRFB uses the same vanadium element in both half cells which prevents crossover contamination of electrolytes from one half cell to the other half cell. VRFB, however, is inherently expensive due to the use of high-cost vanadium and an expensive membrane. All-iron redox flow batteries (IFB) are particularly attractive for grid scale storage applications due to the use of low cost and abundantly available iron, salt, and water as the electrolyte and the non-toxic nature of the system. IFBs have iron in different valence states as both the positive and negative electrolytes for the positive and negative electrodes, respectively. The iron-based positive and negative electrolyte solutions stored in the external storage tanks flow through the stacks of the batteries. The cathode side half-cell reaction involves Fe²⁺ losing electrons to form Fe³⁺ during charge and Fe³⁺ gaining electrons to form Fe²⁺ during discharge; the reaction is given by Eq. 4. The anode side half-cell reaction involves the deposition and dissolution of iron in the form of a solid plate; the reaction is given by Eq. 5. The overall reaction is shown in Eq. 6.

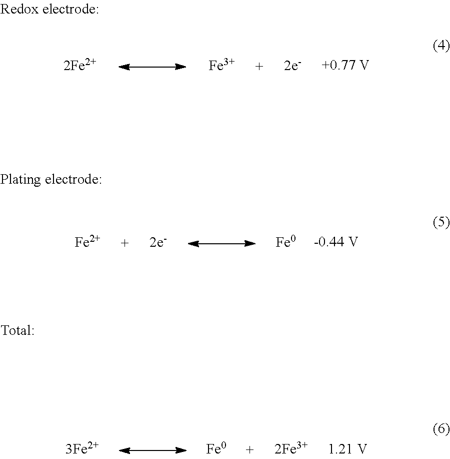

The membrane is one of the materials that make up a battery or electrolysis cell and is an important driver for safety and performance. Some important properties for membranes for flow batteries, fuel cells, and membrane electrolysis include high conductivity, high ionic permeability (porosity, pore size and pore size distribution), high ionic exchange capacity (for ion-exchange membrane), high ionic/electrolyte selectivity (low permeability/crossover to electrolytes), low price (less than $150-200/m²), low area resistance to minimize efficiency loss resulting from ohmic polarization, high resistance to oxidizing and reducing conditions, chemically inert to a wide pH range, high thermal stability together with high proton conductivity (greater than or equal to 120° C. for fuel cell), high proton conductivity at high temperature without H₂O, high proton conductivity at high temperature with maintained high relative humidity, and high mechanical strength (thickness, low swelling).

The membrane is ionically conductive. The ionic conductivity means that the membrane can transport the charge-carrying ions, such as protons or ammonium ion (NH₄⁺), from one side of the membrane to the other side of the membrane to maintain the electric circuit. The electrical balance is achieved by the transport of charge-carrying ions (such as protons, ammonium ions, potassium ions, or sodium ions in all iron redox flow battery system) in the electrolytes across the membrane during the operation of the battery cell. The ionic conductivity (σ) of the membrane is a measure of its ability to conduct charge-carrying ions, and the measurement unit for conductivity is Siemens per meter (S/m). The ionic conductivity (σ) of the ionically conductive membrane is measured by determining the resistance (R) of the membrane between two electrodes separated by a fixed distance. The resistance is determined by electrochemical impedance spectroscopy (EIS) and the measurement unit for the resistance is Ohm (Ω). The membrane area specific resistance (RA) is the product of the resistance of the membrane (R) and the membrane active area (A) and the measurement unit for the membrane area specific resistance is Ω·cm². The membrane ionic conductivity (σ, S/cm) is proportional to the membrane thickness (L, cm) and inversely proportional to the membrane area specific resistance (RA, Ω·cm²).

The performance of the RFB is evaluated by several parameters including area specific resistance, numbers of battery charge/discharge cycling, electrolyte crossover through the membrane, voltage efficiency (VE), coulombic efficiency (CE), and energy efficiency (EE) of the RFB cell. CE is the ratio of a cell's discharge capacity divided by its charge capacity. A higher CE, indicating a lower capacity loss, is mainly due to the lower rate of crossover of electrolyte ions, such as ferric and ferrous ions, through the membrane and reduced H₂ evolution reaction during charging in the iron redox flow battery system. VE is defined as the ratio of a cell's mean discharge voltage divided by its mean charge voltage (See M. Skyllas-Kazacos, C. Menictas, and T. Lim, Chapter 12 on Redox Flow Batteries for Medium- to Large-Scale Energy Storage in Electricity Transmission, Distribution and Storage Systems, A volume in Woodhead Publishing Series in Energy, 2013). A higher VE, indicating a higher ionic conductivity, is mainly due to the low area specific resistance of the battery system. EE is the product of VE and CE and is an indicator of energy loss in charge-discharge processes. EE is an important parameter to evaluate an energy storage system.

One issue for the current all iron RFB system is the high area specific resistance that results in low VE. The area specific resistance is the combination of the resistances from the membrane, the current collectors, the end plates, the electrolytes, the reactions, the interfacial resistance, and other components. Another issue is the loss of capacity in all iron RFB due to the undesired crossover of water and Fe ions through the membrane. Yet another issue is the H₂ evolution reaction during charging. H₂ is formed on the negative side of the battery as Fe²⁺ is plated on the electrode as Fe⁰, which will result in low CE. As battery is charging, hydrogen is formed on the negative side of the battery as Fe²⁺ is plated on the electrode as Fe⁰. Meanwhile, losses are minimal on positive side. Therefore, there is more Fe³⁺ in the positive solution for each cycle until there is no more Fe²⁺ available for charging the battery. The formation of H₂ resulted in low CE.

Recently new cost-effective, non-fluoro polymeric proton or cation exchange membrane materials with low environmental impact for water electrolysis, flow battery, and fuel cell applications in renewable energy systems have been invented. While presumably effective for their intended purposes, it is known that the chemical and electrochemical stability of the non-fluoro polymeric proton or cation exchange membrane material will affect the stability and the lifespan of the membrane electrode assembly (MEA) comprising such material, therefore affect the efficiency and stability of the electrolyzers and fuel cells. Inorganic materials, such as CeO₂, Ce(OH)₄, CeO₂/ZrO₂, Ce(OH)₄/ZrO₂, or mixtures thereof, are free radial scavengers with active redox couple of Ce(IV)/Ce(III) that have been applied to the cation exchange membrane. The catalytic reactions in the MEA for fuel cell or electrolysis generate hydrogen peroxide and radical intermediates, such as hydroperoxyl(HOO·) and hydroxyl(HO·) radicals. These reactive oxygen species result in membrane and ionomer degradation. The incorporation of the inorganic free radial scavengers into the membrane provides improved durability of the membrane for electrochemical reactions. However, the agglomeration of the inorganic particles in the membrane and the interface between the inorganic particles and the polymer matrix in the membrane may result in lower membrane mechanical strength and lower stability.

Accordingly, it would be desirable to provide new cation exchange membranes with improved lifespan.

### BRIEF DESCRIPTION OF THE DRAWINGS

FIG. 1 is an illustration of one embodiment of a PEMWE cell.

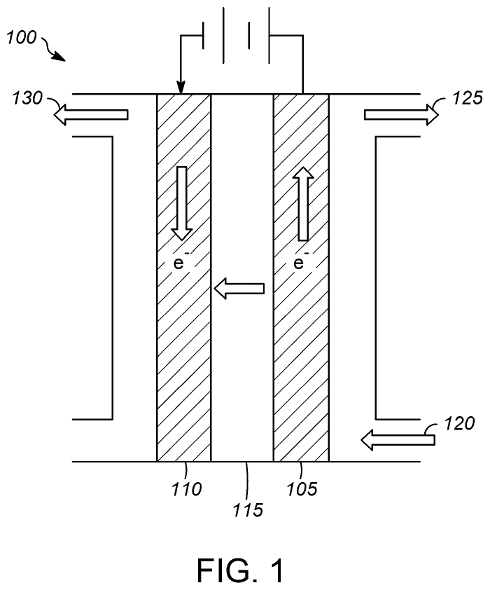

FIG. 2 is an illustration of one embodiment of the synthesis of PI2BPPT free radical scavenging polymer.

FIG. 3 is an illustration of one embodiment of the synthesis of PI2BPPT-SO₃H proton-conducting polymer.

### DESCRIPTION OF THE INVENTION

The present invention provides a novel proton exchange membrane comprising polymeric free radical scavenger. The membrane comprises a blend of a proton-conductive polymer and a free radical scavenging polymer having phenolic hydroxyl groups. The free radical scavenging polymer and the proton-conductive polymer form a miscible polymer blend with no phase separation issues. The proton exchange membrane showed high mechanical strength, high chemical and electrochemical stability, and high proton conductivity, making it suitable for a wide range of electrochemical reactions. It may be used in a wide variety of applications including, but not limited to, fuel cells, electrolyzers, flow batteries, electrodialyzers, waste metal recovery systems, electrocatalytic hydrogen production systems, desalinators, water purifiers, waste water treatment systems, ion exchangers, or CO₂ separators.

The weight ratio of the proton-conductive polymer to the free radical scavenging polymer is generally in the range of 100:1 to 1:2, or 20:1 to 1:1, or 10:1 to 2:1.

Any suitable free radical scavenging polymer having phenolic hydroxyl functional groups, high resistance to oxidizing and reducing conditions, chemically inert to a wide pH range, high thermal stability, high mechanical strength and dimensional stability, and low H₂ and O₂ gas permeabilities can be used.

In one embodiment, the free radical scavenging polymer comprises a plurality of repeating units of formula (II) having phenolic hydroxyl functional groups.

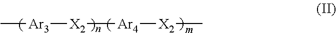

wherein Ar₃ is selected from the group consisting of:

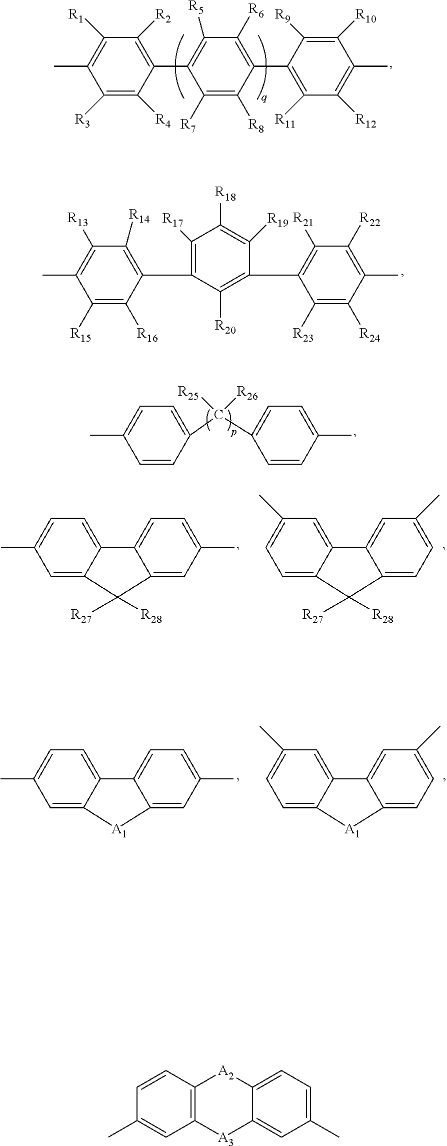

and mixtures thereof;
wherein Ar₄ is selected from:

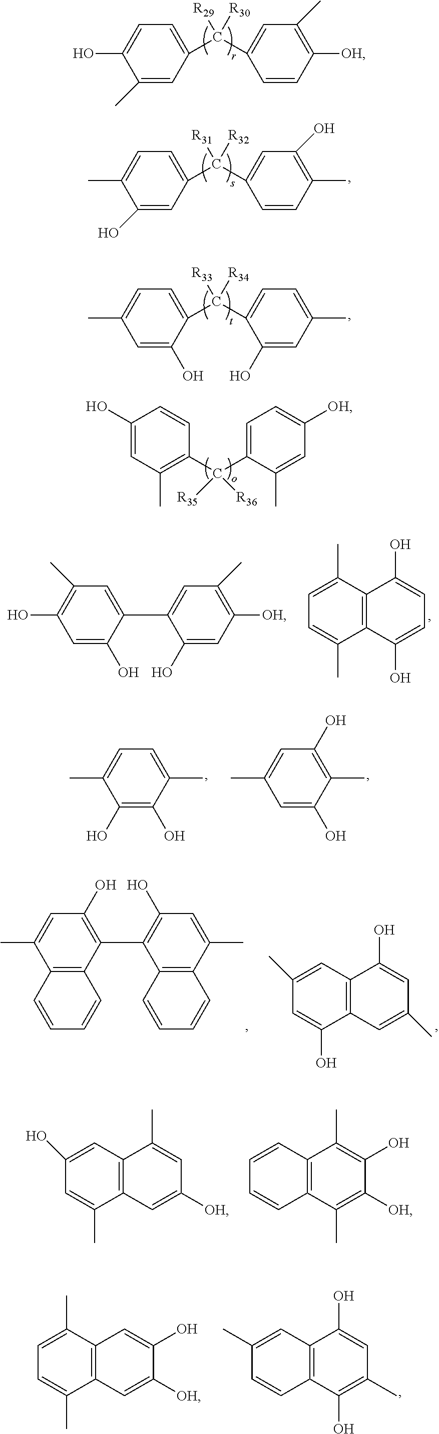

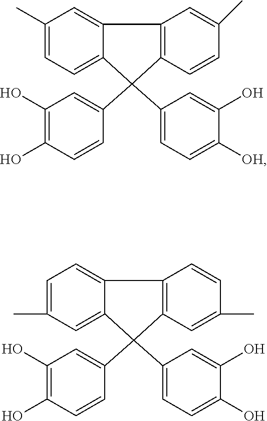

and mixtures thereof;
wherein X₂ is selected from:

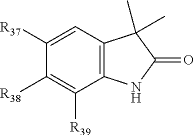

or a mixture of

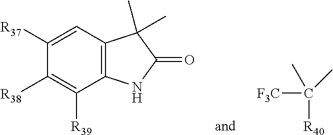

wherein R₁—R₃₆ are each independently hydrogen, a halogen, an alkyl group, an alkenyl group, an alkynyl group, or an aryl group, and wherein the alkyl group, the alkenyl group, the alkynyl group, or the aryl group is optionally substituted with a halogen;
wherein R₃₇—R₄₀ are each independently hydrogen, an alkyl group, an alkenyl group, an alkynyl group, or an aryl group, and wherein the alkyl group, the alkenyl group, the alkynyl group or the aryl group is optionally substituted with a halogen;
wherein the halogen is F, Cl, Br, or I;
wherein A₁, A₂, and A₃ are each independently O, S, or NH;
wherein m is an integer from 5 to 5000;
wherein n is an integer from 0 to 5000;
wherein a molar ratio of n/m is in a range of 0:1 to 20:1;
wherein p is 1, 2, 3, or 4;
wherein q is 0, 1, 2, or 3; and
wherein r, s, t, and o are independently 0, 1, 2, or 3.

In some embodiments, Ar₃ is selected from the group consisting of:

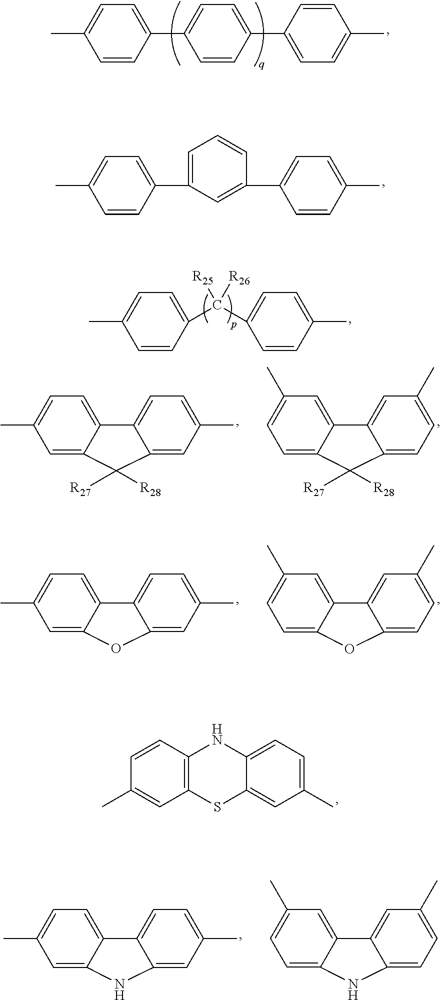

and mixtures thereof,
wherein R₂₅, R₂₆, R₂₇, and R₂₈ are each independently —H or —CH₃;
wherein p is 1 or 2; and
wherein q is 0 or 1.

In some embodiments, Ar₄ is selected from the group consisting of:

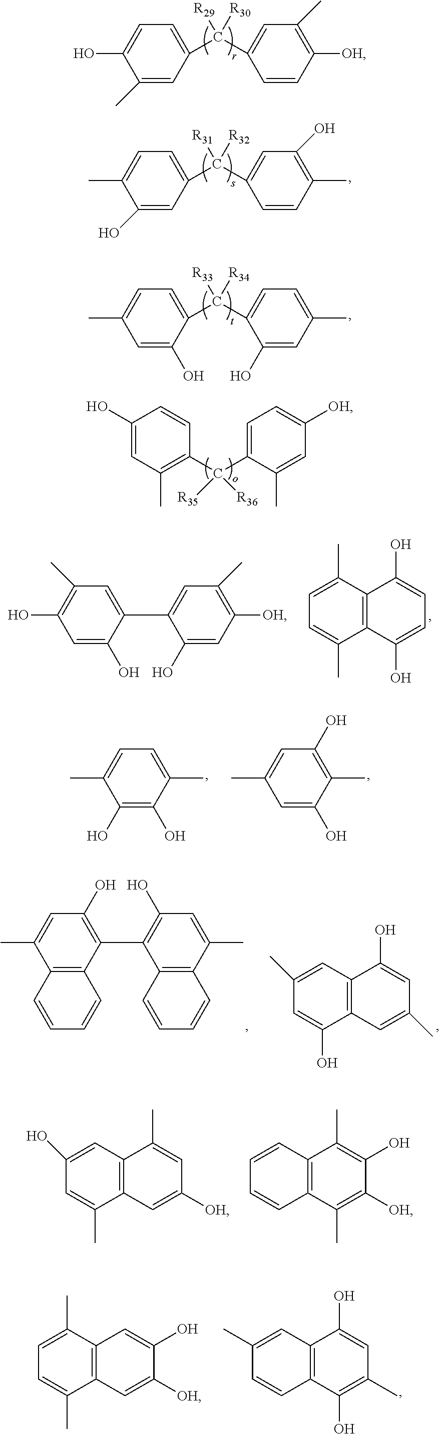

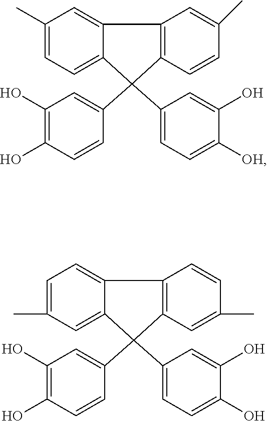

and mixtures thereof;
wherein R₂₉, R₃₀, R₃₁, R₃₂, R₃₃, R₃₄, R₃₅, and R₃₆ are each independently —CH₃ or —CF₃; and
wherein r, s, t, and o are each independently 0 or 1.

In some embodiments, X₂ is

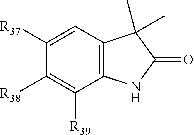

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂.

In some embodiments, wherein X₂ is a mixture of

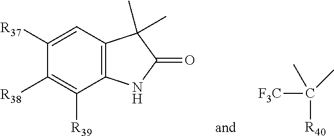

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and
wherein R₄₀ is —CH₃, —CH₂CH₃, or —C₆H₅.

In some embodiments, the proton-conductive polymer in the present proton exchange membrane comprising a blend of a proton-conductive polymer and a free radical scavenging polymer having phenolic hydroxyl groups is selected from a fluorinated proton-conductive polymer, a non-fluorinated proton-conductive polymer, or a combination thereof.

In some embodiments, wherein the non-fluorinated proton-conductive polymer comprises a plurality of repeating units of formula (I)

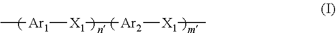

wherein one or more of Ar₁, Ar₂, and X₁ comprises an acid functional group, wherein the acid functional group comprises —SO₃⁻Z⁺, —COO⁻Z⁺, or —PO₃H⁻Z⁺, and wherein Z⁺is H⁺, a metal cation, a quaternary ammonium cation, or mixtures thereof;
wherein Ar₁ is selected from the group consisting of:

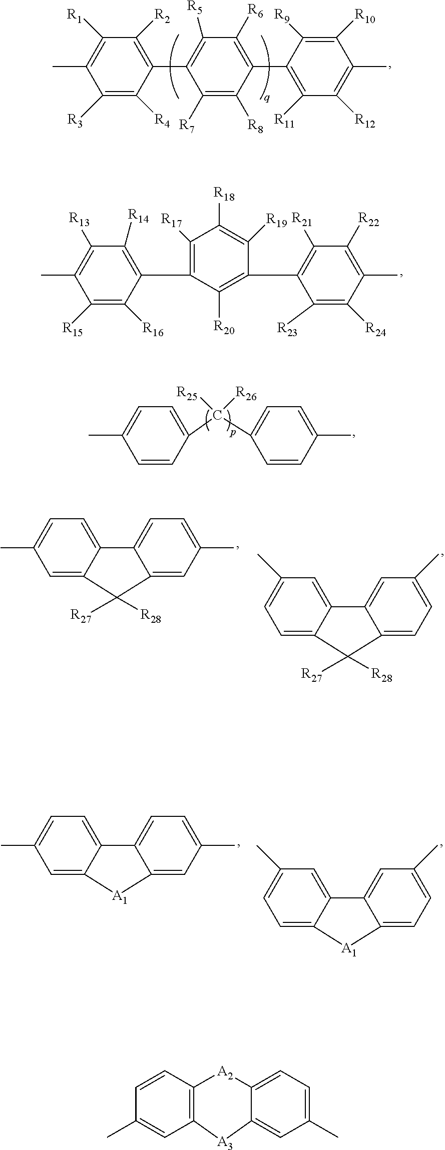

and mixtures thereof;
wherein Ar₂ is selected from the group consisting of:

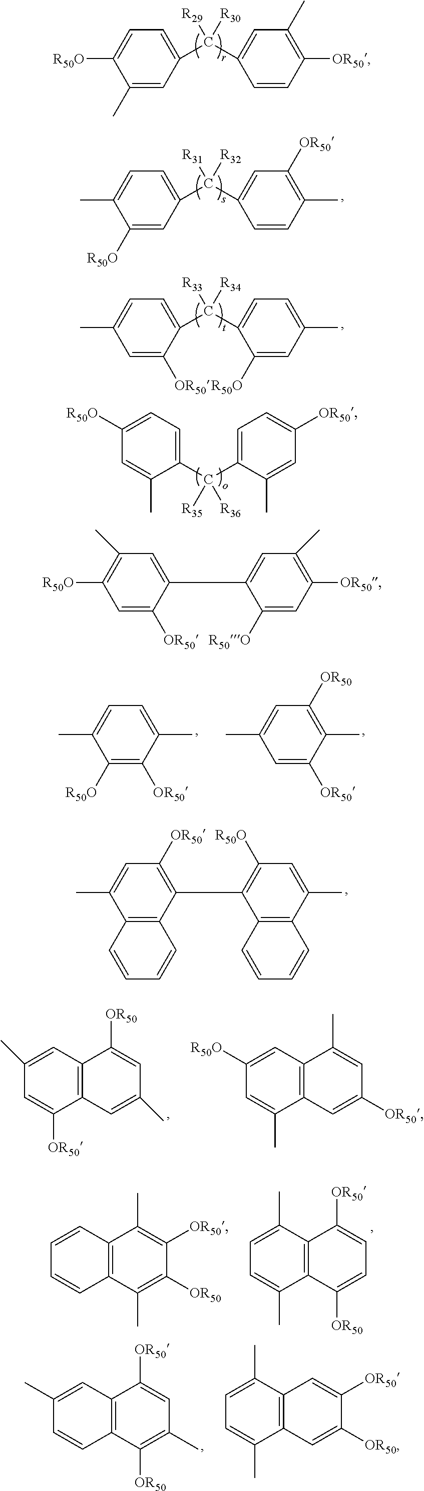

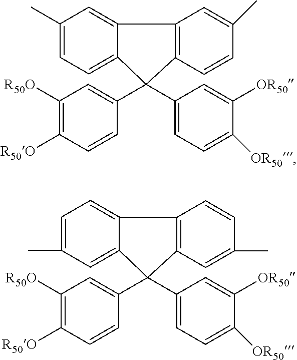

and mixtures thereof; and
wherein X₁ is selected from the group consisting of:

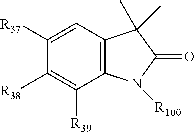

or a mixture of

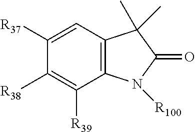

and
one or more of:

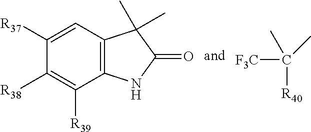

wherein R₁—R₃₆ are each independently hydrogen, a halogen, an alkyl group, an alkenyl group, an alkynyl group, or an aryl group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₁⁺, —COO⁻Z₁⁺, or —PO₃H⁻Z₁⁺, and wherein Z₁⁺ is H⁺, a metal cation, a quaternary ammonium cation, or mixtures thereof;
wherein R₃₇—R₃₉ are each independently hydrogen, a halogen, a nitro group, an alkyl group, an alkenyl group, an alkynyl group, an aryl group, or an alkoxy group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₂⁺, —COO⁻Z₂⁺, or —PO₃H⁻Z₂⁺, and wherein Z₂⁺ is H⁺, a metal cation, a quaternary ammonium cation, or mixtures thereof;
wherein R₄₀ is an alkyl group, an alkenyl group, an alkynyl group, or an aryl group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₃⁺, —COO⁻Z₃⁺, or —PO₃H⁻Z₃⁺, and wherein Z₃⁺ is H^{°}, a metal cation, a quaternary ammonium cation, or mixtures thereof;
wherein R₅₀, R₅₀′, R₅₀″, and R₅₀′″ are each independently hydrogen, a substituted alkyl group, a substituted alkenyl group, a substituted alkynyl group, or a substituted aryl group, and wherein the substituted alkyl group, the substituted alkenyl group, the substituted alkynyl group, or the substituted aryl group are substituted with an acid functional group or are substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof; with the proviso that one or more of R₅₀ and R₅₀′ is not hydrogen, or one or more of R₅₀, R₅₀, R₅₀′, and R₅₀′″ is not hydrogen;
wherein R₁₀₀ is independently a substituted alkyl group, a substituted alkenyl group, a substituted alkynyl group, or a substituted aryl group, and wherein the substituted alkyl group, the substituted alkenyl group, the substituted alkynyl group, or the substituted aryl group is substituted with an acid functional group or is substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof;
wherein the halogen is F, Cl, Br, or I;
wherein A₁, A₂, and A₃ are each independently O, S, or N—R₂₀₀ and wherein R₂₀₀ is hydrogen, a substituted alkyl group, a substituted alkenyl group, a substituted alkynyl group, or a substituted aryl group, and wherein the substituted alkyl group, the substituted alkenyl group, the substituted alkynyl group, or the substituted aryl group is substituted with an acid functional group or is substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof;
wherein p is 1, 2, 3, or 4;
wherein q is 0, 1, 2, or 3;
wherein r, s, t, and o are independently 0, 1, 2, 3, 4, 5, or 6; and
wherein n′ is an integer from 0 to 5000;
wherein m′ is an integer from 5 to 5000; and
wherein a molar ratio of n′/m′ is in a range of 0:1 to 20:1.

In some embodiments, Ar₁ is selected from the group consisting of

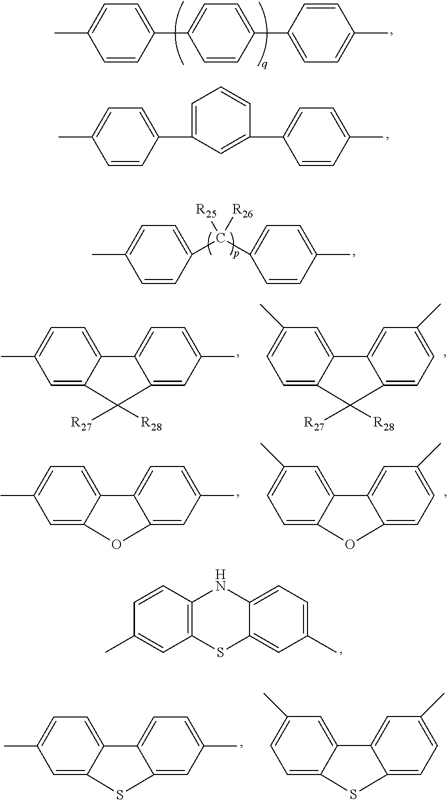

and mixtures thereof,
wherein R₂₅, R₂₆, R₂₇, and R₂₈ are each independently —H or —CH₃;
wherein p is 1 or 2; and
wherein q is 0 or 1.

In some embodiments, X₁ is

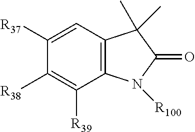

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and
wherein R₁₀₀ is —(CH₂)₃SO₃⁻Z₄⁺ and wherein Z₄⁺is H⁺, a metal cation, a quaternary ammonium cation, or mixtures thereof.

In some embodiments, X₁ is a mixture of

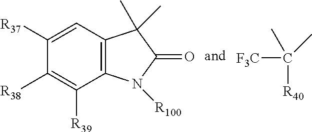

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂;
wherein R₄₀ is —CH₃, —CH₂CH₃, or —C₆H₅; and
wherein R₁₀₀ is —(CH₂)₃SO₃⁻Z₄⁺ and wherein Z₄⁺is H⁺, a metal cation, a quaternary ammonium cation, or mixtures thereof.

In some embodiments, X₁ is a mixture of

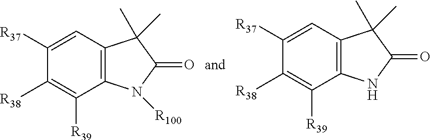

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and

wherein R₁₀₀ is —(CH₂)₃SO₃⁻Z₄⁺ and wherein Z₄⁺is H⁺, a metal cation, a quaternary ammonium cation, or mixtures thereof.

In some embodiments, wherein X₁ is a mixture of

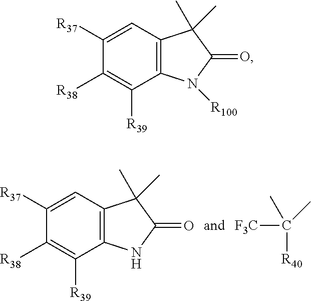

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂,
wherein R₄₀ is —CH₃, —CH₂CH₃, or —C₆H₅; and
wherein R₁₀₀ is —(CH₂)₃SO₃⁻Z₄⁺ and wherein Z₄⁺is H⁺, a metal cation, a quaternary ammonium cation, or mixtures thereof.

In some embodiments, Ar₁ is selected from the group consisting of

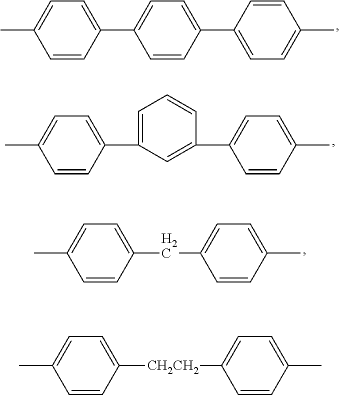

and mixtures thereof; or
   wherein Ar₂ is selected from the group consisting of:

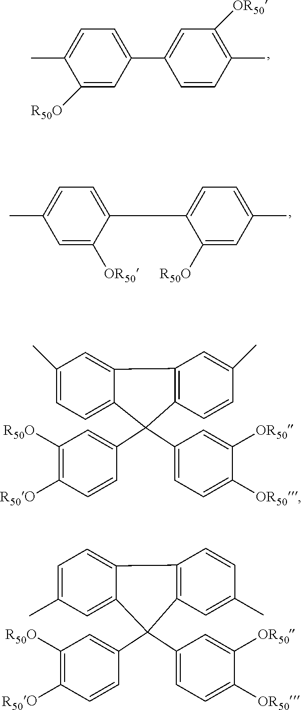

and mixtures thereof;
wherein R₅₀, R₅₀′, R₅₀″, and R₅₀′″ are each independently hydrogen or —(CH₂)₃SO₃⁻Z₄⁺ and wherein Z₄⁺ is H⁺, Na⁺, K⁺, NH₄⁺, or mixtures thereof, with the proviso that one or more of R₅₀ and R₅₀′ is not hydrogen, or one or more of R₅₀, R₅₀′, R₅₀″, and R₅₀′″ is not hydrogen;
   or both.

In some embodiments, X₁ is

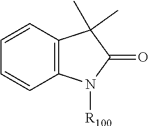

or a mixture of

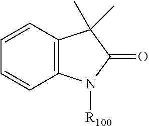

and one or more of:

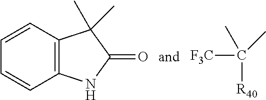

wherein R₁₀₀ is —(CH₂)₃SO₃⁻Z₄⁺ and wherein Z₄⁺is H⁺, Na⁺, K⁺, NH₄⁺, or mixtures thereof; and
wherein R₄₀ is —CH₃, —CH₂CH₃, or —C₆H₅.

The free radical scavenging polymer comprising a plurality of repeating units of formula II was synthesized from monomers Ar₃′, Ar₄′, and X₂′, such as p-terphenyl as Ar₃′ and 2, 2′-dihydroxybiphenyl as Ar₄′ with isatin as X₂′, via a superacid catalyzed polyhydroxyalkylation reaction.

In some embodiments, Ar₃′ is selected from the group consisting of:

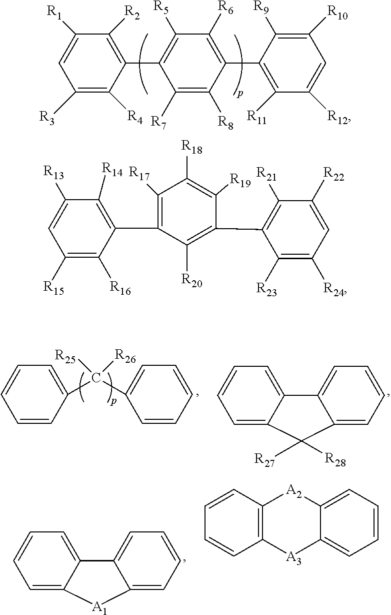

and mixtures thereof. In some embodiments, Ar₄′ is selected from the group consisting of:

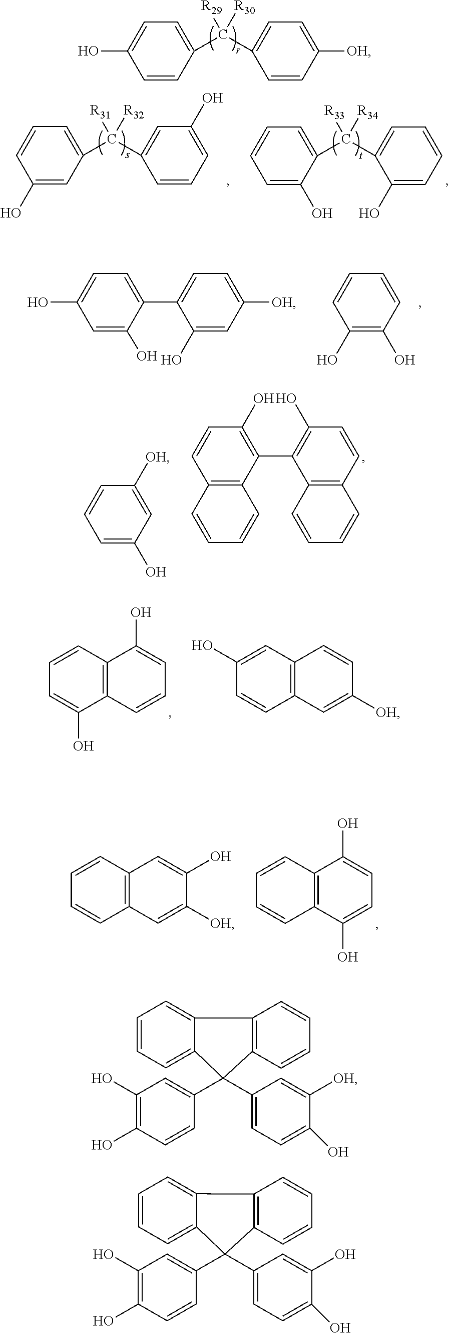

and mixtures thereof.

In some embodiments, X₂′ is selected from the group consisting essentially of:

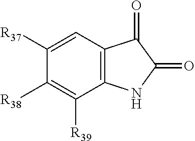

or a mixture of

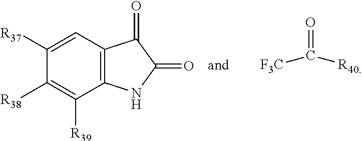

The free radical scavenging polymer comprising a plurality of repeating units of formula II has a polymer backbone free of ether bonds, which results in high chemical stability of the polymer. The incorporation of electron-rich monomer Ar₃′ into the polymer provides a hydrophobic polymer backbone and the incorporation of monomers Ar₄′ with phenolic hydroxyl functional groups and X₄′ with isatin-based moieties not only increase the rigidity and free volume of the polymer, but also allows the introduction of phenolic hydroxyl functional groups to the polymer side chains for free radical scavenging. Therefore, the free radical scavenging polymer has low cost, high chemical and thermal stability, high mechanical stability, and significantly reduced gas permeability.

In some cases, the monomer X₂′ is a mixture of an isatin-based monomer and a non-isatin-based monomer to enable the formation of a high molecular weight polymer. The molar ratio of Ar₃′ monomer to Ar₄′ monomer for the synthesis of the polymer comprising a plurality of repeating units of formula (II) can be in a range of 0:1 to 20:1, or in a range of 10:1 to 1:10, or in a range of 5:1 to 1:5. The molar ratio of X₂′ monomer to Ar₃′ and Ar₄′ monomers for the synthesis of the polymer comprising a plurality of repeating units of formula (II) can be in a range of 1.2:1 to 1:1.2, or in a range of 1.1:1 to 1:1.1, or in a range of 1.05:1 to 1:1.05.

The superacid catalyzed polyhydroxyalkylation reaction can be carried out at 0° C. to 50° C., or at 10° C. to 30° C., or at 20° C. to 30° C. for 2 h to 72 h, or 10 h to 48 h, or 12 to 24 h. Suitable superacid catalysts include, but are not limited to, trifluoromethanesulfonic acid (CF₃SO₃H (TFSA)), methanesulfonic acid (MSA), fluorosulfuric acid (FSO₃H), or mixtures thereof. Solvents for the polyhydroxyalkylation reaction are those that can dissolve one or more of the monomers. Suitable solvents include, but are not limited to, methylene chloride, chloroform, trifluoroacetic acid (TFA), or mixtures thereof.

The proton-conducting polymer comprising a plurality of repeating units of formula (I) was synthesized from monomers Ar₁′, Ar₂′, and X₁′, such as p-terphenyl as Ar₁′ and 2, 2′-dihydroxybiphenyl as Ar₂′ with isatin as X₁′, via a super acid catalyzed polyhydroxyalkylation reaction to form the precursor polymer comprising phenolic hydroxyl functional groups and isatin-based moieties, followed by a nucleophilic substitution reaction or a grafting reaction on the phenolic hydroxyl functional groups and the —NH groups on the isatin-based moieties, and then optionally an acidification reaction to incorporate hydrophilic proton-conducting acid functional groups to the polymer side chains. The proton-conducting polymer comprising a plurality of repeating units of formula (I) has a polymer backbone free of ether bonds, which results in high chemical stability of the polymer. The incorporation of electron-rich monomer Ar₁′ into the polymer provides a hydrophobic polymer backbone and the incorporation of monomers Ar₂′ with phenolic hydroxyl functional groups and X₁′ with isatin-based moieties not only increase the rigidity and free volume of the polymer, but also allows the introduction of hydrophilic proton-conducting acid functional groups to the polymer side chains via a nucleophilic substitution reaction or a grafting reaction. Therefore, the proton-exchange membranes prepared from this type of polymer have low cost, high chemical and thermal stability, high mechanical stability, lower membrane area specific resistance, significantly reduced gas or electrolyte crossover, and high proton (H⁺) conductivity.

In some embodiments, Ar₁′ is selected from the group consisting of:

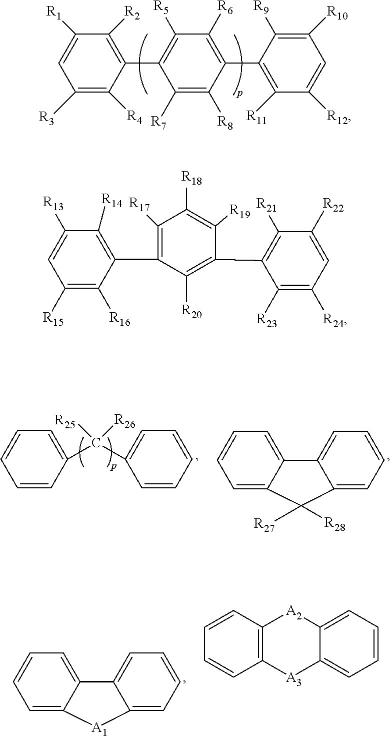

and mixtures thereof.

In some embodiments. Ar₂′ is selected from the group consisting of:

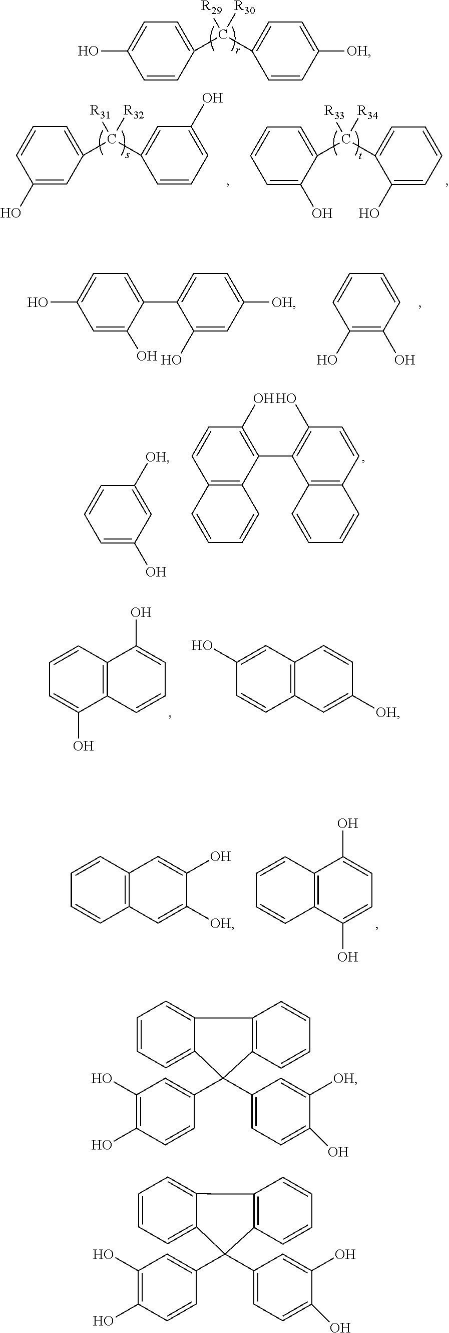

and mixtures thereof.

In some embodiments, X₁′ is selected from the group consisting essentially of:

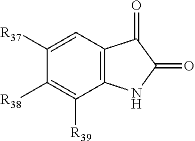

or a mixture of

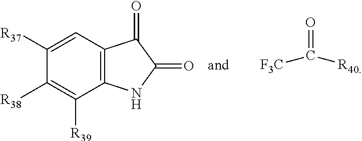

In some cases, the monomer X₁′ is a mixture of an isatin-based monomer and a non-isatin-based monomer to enable the formation of a high molecular weight polymer. The molar ratio of Ar₁′ monomer to Ar₂′ monomer for the synthesis of the polymer comprising a plurality of repeating units of formula (I) can be in a range of 0:1 to 20:1, or in a range of 10:1 to 1:10, or in a range of 5:1 to 1:5. The molar ratio of X₁′ monomer to Ar₁′ and Ar₂′ monomers for the synthesis of the polymer comprising a plurality of repeating units of formula (I) can be in a range of 1.2:1 to 1:1.2, or in a range of 1.1:1 to 1:1.1, or in a range of 1.05:1 to 1:1.05.

The superacid catalyzed polyhydroxyalkylation reaction can be carried out at 0° C. to 50° C., or at 10° C. to 30° C., or at 20° C. to 30° C. for 2 h to 72 h, or 10 h to 48 h, or 12 to 24 h. Suitable superacid catalysts include, but are not limited to, trifluoromethanesulfonic acid (CF₃SO₃H (TFSA)), methanesulfonic acid (MSA), fluorosulfuric acid (FSO₃H), or mixtures thereof. Solvents for the polyhydroxyalkylation reaction are those that can dissolve one or more of the monomers. Suitable solvents include, but are not limited to, methylene chloride, chloroform, trifluoroacetic acid (TFA), or mixtures thereof.

The nucleophilic substitution reaction or grafting reaction can be carried out at about 20° C. to about 150° C., or at about 30° C. to about 130° C., or at about 50° C. to about 100° C. for 2 h to 72 h, or 5 h to 48 h, or 5 to 24 h. Solvents for the nucleophilic substitution reaction or grafting reaction are those that can dissolve the precursor polymer comprising phenolic hydroxyl functional groups and isatin-based moieties. Suitable solvents include, but are not limited to, N-methyl-2-pyrrolidone (NMP), dimethylacetamide (DMAc), dimethylformamide (DMF), dimethyl sulfoxide (DMSO), dioxanes, 1,3-dioxolane, and mixtures thereof. In some embodiments, anhydrous K₂CO₃ was used for the nucleophilic substitution reaction or grafting reaction to catalyze the reaction. Suitable electrophiles for the nucleophilic substitution reaction or the grafting reaction include, but are not limited to, sodium bromopropanesulfate and 1,3-propanesultone.

The acids suitable for the final optional acidification reaction include, but are not limited to, hydrochloric acid, sulfuric acid, or phosphoric acid.

The proton-conducting polymer comprising a plurality of repeating units of formula (I) has a weight average molecular weight in a range of 10,000 to 1,000,000 Daltons, or in a range of 50,000 to 500,000 Daltons.

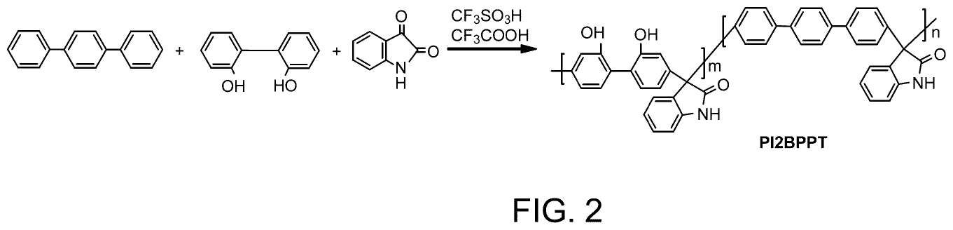

In one embodiment, a free radical scavenging polymer having phenolic hydroxyl groups, poly(isatin-2, 2′-biphenol-p-terphenyl) (abbreviated as PI2BPPT), was synthesized according to FIG. 2 from isatin, 2,2′-biphenol, and p-terphenyl monomers via a super acid catalyzed polyhydroxyalkylation reaction. The chemical structure of PI2BPPT free radical scavenging polymer was identified by ¹H NMR.

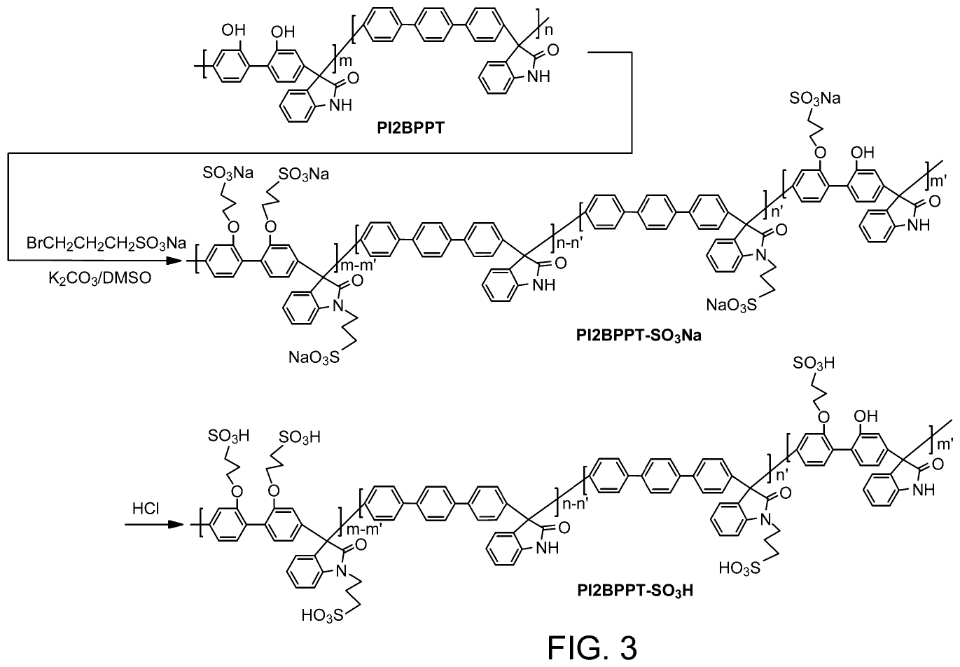

In one embodiment, a proton-conducting polymer, sulfonated poly(isatin-2, 2′-biphenol-p-terphenyl) (abbreviated as PI2BPPT-SO₃H), was synthesized according to FIG. 3 from PI2BPPT polymer via a nucleophilic substitution reaction to graft sodium propanesulfate functional groups on the 2, 2′-biphenol unit and the isatin unit of the PI2BPPT polymer, and finally an acidification reaction to convert sodium propanesulfate functional groups on the polymer to propanesulfonic acid functional groups to form the sulfonated non-fluorinated ether-free aromatic proton-conducting polymer PI2BPPT-SO₃H. The degree of sulfonation was controlled by the amount of sodium bromopropanesulfate and the reaction conditions. The sodium propanesulfate functional groups were selectively grafted on —OH of the 2, 2′-biphenol unit and —NH of the isatin unit. The chemical structure of PI2BPPT-SO₃H polymer was identified by ¹H NMR.

The free radical scavenging polymer PI2BPPT and the proton-conductive polymer PI2BPPT-SO₃H were blended together and used for the preparation of PI2BPPT/PI2BPPT-SO₃H blend proton exchange membrane. The membrane showed high H⁺ conductivity of 141 mS/cm and high stability in acid solution at 80° C.

In some embodiments, the proton exchange membrane comprising the free radical scavenging polymer comprising the plurality of repeating units of formula (II) and the proton-conducting polymer comprising a plurality of repeating units of formula (I) comprises a nonporous symmetric dense film membrane, an integrally-skinned asymmetric membrane, a reinforced composite membrane, or a thin film composite membrane. By “dense” we mean that the membrane does not have pores larger than 1 nm.

In some embodiments, the reinforced composite membrane or the thin film composite membrane comprises a porous substrate membrane impregnated or coated with a blend of free radical scavenging polymer and a proton-conducting polymer. The porous substrate membrane is prepared from a polymer different from the free radical scavenging polymer and the proton-conducting polymer.

In some embodiments, the nonporous symmetric dense film membrane, the integrally-skinned asymmetric membrane, the reinforced composite membrane, or the thin film composite membrane may be a flat sheet membrane.

In some embodiments, the nonporous symmetric dense film proton-exchange membrane comprising the free radical scavenging polymer comprising the plurality of repeating units of formula (II) and the proton-conducting polymer comprising a plurality of repeating units of formula (I) is prepared using a method comprising: 1) dissolving the free radical scavenging polymer comprising the plurality of repeating units of formula (II) and the proton-conducting polymer comprising a plurality of repeating units of formula (I) in a solvent to form a blend polymer casting solution; 2) casting the blend polymer casting solution on a nonporous substrate to form a uniform layer of the blend polymer casting solution; 3) drying the blend polymer casting solution layer to form a dried membrane on the nonporous substrate at 50° C. to 180° C., or at 50° C. to 120° C., or at 80° C. to 120° C. to form the nonporous symmetric dense film proton-exchange membrane. The nonporous substrate is removed from the membrane when the membrane is used in a desired application. The solvent used to dissolve the proton-conducting polymer and the free radical scavenging polymer can be selected from, but is not limited to, NMP, DMAc, DMF, DMSO, 1,3-dioxolane, or mixtures thereof. The nonporous substrate used for the fabrication of the nonporous symmetric dense film membrane can be selected from, but is not limited to, glass plate, polyolefin film, polyester film, or fluorocarbon-based polymer film such as poly(tetrafluoroethylene) (PTFE) and poly(vinylidene fluoride) (PVDF) film.

In some embodiments, the integrally-skinned asymmetric proton-exchange membrane is prepared using a method comprising: 1) making a proton-exchange membrane casting solution comprising the free radical scavenging polymer comprising the plurality of repeating units of formula (II) and the proton-conducting polymer comprising a plurality of repeating units of formula (I), solvents which are miscible with water and can dissolve the polymers, and non-solvents which cannot dissolve the polymers; 2) casting a layer of the proton-exchange membrane casting solution onto a supporting substrate; 3) evaporating the solvent and non-solvent from the surface of the coated layer and then coagulating the coated polymer layer in a coagulating bath to form the integrally-skinned asymmetric membrane structure; 5) drying the membrane at 50° C. to 150° C., or at 50° C. to 120° C., or at 80° C. to 120° C. to form the integrally-skinned asymmetric proton-exchange membrane. In some embodiments, the supporting substrate is removed from the membrane when the membrane is used in a desired application. In some embodiments, the supporting substrate is part of the final integrally-skinned asymmetric proton-exchange membrane. The supporting substrate may comprise polyolefin such as polypropylene and polyethylene, polyester, polyamide such as Nylon 6 and Nylon 6,6, cellulose, or fluorocarbon-based polymer such as PTFE and PVDF. The solvents for the preparation of the integrally-skinned asymmetric membrane include, but are not limited to, NMP, DMAc, DMF, DMSO, dioxanes, 1,3-dioxolane, and mixtures thereof. The non-solvents for the preparation of the integrally-skinned asymmetric membrane include, but are not limited to, acetone, methanol, ethanol, tetrahydrofuran (THF), toluene, n-octane, n-decane, lactic acid, citric acid, isopropanol, and mixtures thereof. The integrally-skinned asymmetric membrane may have a thin nonporous dense layer less than 500 nm on a microporous support layer.

In some embodiments, the reinforced composite proton-exchange membrane is prepared using a method comprising: 1) dissolving the free radical scavenging polymer comprising the plurality of repeating units of formula (II) and the proton-conducting polymer comprising a plurality of repeating units of formula (I) in a solvent to form a polymer solution; 2) impregnating a porous matrix support membrane with the polymer solution to fill the pores with the polymers via dip-coating, soaking, spraying, painting, or other known conventional solution impregnating method; 3) drying the impregnated membrane at 50° C. to 150° C., or at 50° C. to 120° C., or at 80° C. to 120° C. to form the reinforced composite proton- exchange membrane with interconnected polymer domains in a porous matrix. The solvents for the preparation of the thin film composite proton-exchange membrane include, but are not limited to, NMP, DMAc, DMF, DMSO, dioxanes, 1,3-dioxolane, and mixtures thereof. The porous matrix should have good thermal stability (stable up to at least 120° C.), high stability under high pH condition (e.g., pH greater than 8), high resistance to oxidizing and reducing conditions (insoluble and no performance drop under oxidizing and reducing conditions), high mechanical strength (no dimensional change under the system operation conditions), as well as other factors dictated by the operating conditions for electrochemical reactions. The porous matrix must be compatible with the electrochemical cell chemistry and meet the mechanical demands of cell stacking or winding assembly operations.

The polymers suitable for the preparation of the porous matrix can be selected from, but not limited to, polyolefins such as polyethylene and polypropylene, polyamide such as Nylon 6 and Nylon 6,6, polyester, cellulose acetate, polybenzimidazole, fluorocarbon-based polymers such as PTFE and PVDF, polycarbonate, cellulose, or combinations thereof. These polymers provide a range of properties such as low cost, high stability in alkaline water, good mechanical stability, and ease of processability for porous matrix fabrication.

The porous matrix can be either a non-woven matrix or a woven matrix and has either a symmetric porous structure or an asymmetric porous structure. The porous matrix can be formed by an electrospinning process, a phase inversion membrane fabrication approach followed by direct air drying, or by phase inversion followed by solvent exchange methods. The porous matrix also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the pores. The wet processing of polyolefin porous matrix is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the porous matrix can be in a range of 10-400 micrometers, or a range of 10-200 micrometers, or a range of 10-100 micrometers, or a range of 20-100 micrometers. The pore size of the porous matrix can be in a range of 1 micrometer to 500 micrometers, or a range of 10 micrometer to 200 micrometers, or a range of 50 micrometers to 100 micrometer.

In some embodiments, the thin film composite proton-exchange membrane is prepared using a method comprising: 1) dissolving the free radical scavenging polymer comprising the plurality of repeating units of formula (II) and the proton-conducting polymer comprising a plurality of repeating units of formula (I) in a solvent to form a polymer coating solution; 2) coating a layer of the polymer coating solution on one surface of a microporous support membrane via dip-coating, meniscus coating, spin coating, casting, soaking, spraying, painting, or other known conventional solution coating technologies; 3) drying the coated membrane at 50° C. to 150° C., or at 50° C. to 120° C., or at 80° C. to 120° C. to form the thin film composite proton-exchange membrane. The solvents for the preparation of the thin film composite proton-exchange membrane include, but are not limited to, NMP, DMAc, DMF, DMSO, dioxanes, 1,3-dioxolane, and mixtures thereof. The microporous support membrane should have good thermal stability (stable up to at least 120° C.), high stability under high pH condition (e.g., pH greater than 8), high resistance to oxidizing and reducing conditions (insoluble and no performance drop under oxidizing and reducing conditions), high mechanical strength (no dimensional change under the system operation conditions), as well as other factors dictated by the operating conditions for electrochemical reactions. The microporous support membrane must be compatible with the electrochemical cell chemistry and meet the mechanical demands of cell stacking or winding assembly operations.

The polymers suitable for the preparation of the microporous support membrane can be selected from, but not limited to, polyolefins such as polyethylene and polypropylene, polyamide such as Nylon 6 and Nylon 6,6, polyester, cellulose acetate, polybenzimidazole, fluorocarbon-based polymer such as PTFE and PVDF, polycarbonate, cellulose, or combinations thereof. These polymers provide a range of properties such as low cost, high stability in alkaline water or acidic water, good mechanical stability, and ease of processability for membrane fabrication.

The microporous support membrane can have either a symmetric porous structure or an asymmetric porous structure. The asymmetric microporous support membrane can be formed by a phase inversion membrane fabrication approach followed by direct air drying, or by phase inversion followed by solvent exchange methods. The microporous support membrane also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-400 micrometers, or a range of 10-200 micrometers, or a range of 10-100 micrometers, or a range of 20-100 micrometers. The pore size of the microporous membrane can be in a range of 10 nanometers to 50 micrometers, or a range of 50 nanometers to 10 micrometers, or a range of 0.2 micrometers to 1 micrometer.

Another aspect of the invention is a membrane electrode assembly. In one embodiment, the membrane electrode assembly comprises: a proton-exchange membrane comprising a blend of a proton-conductive polymer and a free radical scavenging polymer having phenolic hydroxyl functional groups; an anode comprising an anode catalyst on a first surface of the proton-exchange membrane; and a cathode comprising a cathode catalyst on a second surface of the proton-exchange membrane.

In some embodiments, the membrane electrode assembly further comprises: an anode gas diffusion layer adjacent to the anode; and a cathode gas diffusion layer adjacent to the cathode. In some embodiments, the anode and the cathode catalysts are platinum group metal (PGM) electrocatalysts or PGM-free electrocatalysts. The anode and the cathode catalysts are for oxygen evolution reaction and hydrogen evolution reaction, respectively. The anode and the cathode catalysts should have good electrical conductivity, and good electrocatalytic activity and stability. Suitable cathode catalysts can be selected from, but are not limited to, carbon supported platinum (Pt/C), non-platinum group metal incorporated Pt-based catalysts, and mixtures thereof. Suitable anode catalysts can be selected from, but are not limited to, iridium (Ir)-based catalysts, Ir-ruthenium (Ru)-based catalysts, nickel (Ni), iron (Fe), tungsten (W) or cobalt (Co) incorporated Ir-based catalysts or Ir—Ru-based catalysts. Ni—Fe alloy, Ni—Mo alloy, spinel CuₓCo₃ₓO₃, Ni—Fe layered double hydroxide nanoplates on carbon nanotubes, and mixtures thereof. The anode catalysts can be unsupported or immobilized on conductive supports.

In some embodiments, the anode comprising an anode catalyst on a first surface of the proton-exchange membrane is formed by coating an anode catalyst ink on the first surface of the proton-exchange membrane via meniscus coating, knife coating, Mayer rod coating, spray coating, painting, or other known conventional ink coating technologies, followed by drying the coated proton-exchange membrane.

In some embodiments, the cathode comprising a cathode catalyst on a second surface of the proton-exchange membrane is formed by coating a cathode catalyst ink on the second surface of the proton-exchange membrane via meniscus coating, knife coating, Mayer rod coating, spray coating, painting, or other known conventional ink coating technologies, followed by drying the coated proton-exchange membrane.

In some embodiments, the anode comprising an anode catalyst on a first surface of the proton-exchange membrane and the cathode comprising a cathode catalyst on a second surface of the proton-exchange membrane are formed simultaneously by coating an anode catalyst ink on the first surface of the proton-exchange membrane and a cathode catalyst ink on the second surface of the proton-exchange membrane via meniscus coating, knife coating, Mayer rod coating, spray coating, painting, or other known conventional ink coating technologies, followed by drying the coated proton-exchange membrane.

In some embodiments, the anode catalyst ink comprises the anode catalyst, a proton exchange ionomer as a binder, and a solvent. In some embodiments, the cathode catalyst ink comprises the cathode catalyst, a proton exchange ionomer as a binder, and a solvent. The proton exchange ionomer binder creates H transport pathways between the membrane and the reaction sites within the electrodes and thus drastically improves the utilization of the electrocatalyst particles while reducing the internal resistance. The proton exchange ionomer binder can be the proton-conducting polymer comprising a plurality of repeating units of formula (I), or a proton exchange ionomer having a chemical structure similar to the proton-conducting polymer described above, so that the binder will allow low interfacial resistance and similar expansion in contact with water to avoid catalyst delamination, but high H conductivity and high oxygen and hydrogen permeance. The solvent can be selected from, but is not limited to, water, alcohol, or a mixture thereof.

The anode gas diffusion layer and the cathode gas diffusion layer simultaneously transport electrons, heat, and products with minimum voltage, current, thermal, interfacial, and fluidic losses. The cathode and anode gas diffusion layers can be made from, but are not limited to, gold (Au)- or platinum (Pt)-coated stainless steel, titanium meshes, titanium felts, or titanium foams.

### Examples

### Example 1: Synthesis of Poly(Isatin-4, 4′-Biphenol-p-Terphenyl) Free Radical Scavenging Polymer Having Phenolic Hydroxyl Functional Groups (Abbreviated as PI4BPPT)

Poly(isatin-4, 4′-biphenol-p-terphenyl) free radical scavenging polymer having phenolic hydroxyl functional groups (abbreviated as PI4BPPT) was synthesized from three monomers, p-terphenyl (9.79 g, 42.5 mmol), 4,4′-biphenol (1.40 g, 7.5 mmol), and isatin (7.36 g, 50 mmol). The three monomers were charged to a 500 mL three necked flask equipped with an overhead mechanical stirrer. Anhydrous methylene chloride (50 ml) was added to the flash and stirred for 5 min to form a suspension. The flask was then immersed in an ice bath to keep the reaction at low temperature. A mixture of trifluoromethanesulfonic acid (50 mL) and trifluoroacetic acid (25 mL) was added to the flask dropwise. The reaction continued for 24 h. The resulting viscous, dark blue solution was poured slowly into water under stirring. The solid was shredded into powders by a blender, filtered, washed with water, and immersed in 0.5 M K₂CO₃ overnight to remove the acids completely. The polymer was filtered and washed thoroughly by water followed by drying at 60° C. under vacuum. The yield of PI4BPPT was 97%.

### Example 2: Synthesis of Sulfonated Poly(Isatin-4, 4′-Biphenol-p-Terphenyl) Proton-Conductive Polymer (Abbreviated as PI4BPPT-SO₃H)

Sulfonated poly(isatin-4, 4′-biphenol-p-terphenyl) proton-conducting polymer (abbreviated as PI4BPPT-SO₃H) was synthesized from PI4BPPT polymer as described in Example 1. To a 400 ml glass bottle, PI4BPPT polymer (10 g) was dissolved in DMAc (60 g). 1,3-propanesultone (5 g) was added quickly. The solution was stirred for 3 days at room temperature. The temperature was increased to 60° C. The reaction was continued for another 6 h. The resultant viscous, yellow solution was poured slowly into water under stirring. The solid was filtered, washed with water, and immersed in 0.5 M K₂CO₃ overnight. The polymer was filtered and washed thoroughly by water followed by drying at 80° C. under vacuum. The yield of PI4BPPT-SO₃H was 95%.

### Example 3: Preparation of PI4BPPT/PI4BPPT-SO₃H Blend Proton Exchange Membrane

A PI4BPPT/PI4BPPT-SO₃H blend proton exchange membrane was prepared by dissolving PI4BPPT free radical scavenging polymer and PI4BPPT-SO₃H proton-conductive polymer in DMSO solvent to form a 15 wt % PI4BPPT/PI4BPPT-SO₃H blend polymer solution and casting the solution on a glass plate with a knife gap of 22 mil. After drying at 60° C. overnight, the membrane was detached and further dried in vacuum oven at 100° C. for 2 days to form PI4BPPT/PI4BPPT-SO₃H blend proton exchange membrane.

### Example 4: Synthesis of Poly(Isatin-2, 2′-Biphenol-p-Terphenyl) Free Radical Scavenging Polymer Having Phenolic Hydroxyl Functional Groups (Abbreviated as PI2BPPT)

As shown in FIG. 2, poly(isatin-2, 2′-biphenol-p-terphenyl) (abbreviated as PI2BPPT) free radical scavenging polymer comprising different 2, 2′-biphenol/p-terphenyl molar ratios were synthesized via a super acid catalyzed polyhydroxyalkylation reaction of three monomers, p-terphenyl, isatin, and 2,2′-biphenol. Several PI2BPPT polymers comprising phenolic hydroxyl functional groups were synthesized by varying the molar ratios of 2,2′-biphenol to p-terphenyl, such as 15:85 (abbreviated as PI2BPPT-15), 50:50 (abbreviated as PI2BPPT-50), 75:25 (abbreviated as PI2BPPT-75), and 100:0 (abbreviated as PI2BPPT-100).

As an example, PI2BPPT-50 was synthesized from two monomers, p-terphenyl (11.5 g, 50 mmol) and 2, 2′-biphenol (9.3 g, 50 mmol), by charging them to a 500 mL three necked flask equipped with an overhead mechanical stirrer. Trifluoromethanesulfonic acid (60 ml) was added to the flask and stirred for 5 min to form a suspension. The flask was then immersed in an ice bath to keep the reaction at low temperature. In a separate bottle, isatin (15.0 g, 102 mmol) was dissolved in trifluoroacetic acid (60 mL) and carefully transferred to a dripping funnel. Anhydrous methylene chloride (30 ml) was used to wash the bottle and transfer all the isatin solution to the dripping funnel. The isatin solution was added dropwise to the flask containing p-terphenyl and 2, 2′-biphenol within 2 h. Thereafter, the reaction was continued for additional 4-5 h. The resulting viscous, bluish solution was poured slowly into water under stirring. The light-yellow solid was shredded into powders in a blender, filtered, washed with water, and stirred in ethanol overnight. The polymer was filtered and washed thoroughly by ethanol followed by drying at 100° C. under vacuum. The yield of the white precursor polymer PI2BPPT-50 was 95%.

### Example 5: Synthesis of Sulfonated Poly(Isatin-2, 2′-Biphenol-p-Terphenyl) Proton-Conductive Polymer (Abbreviated as PI2BPPT-SO₃H)

As shown in FIG. 3, sulfonated poly(isatin-2, 2′-biphenol-p-terphenyl) proton-conducting polymer was synthesized from PI2BPPT polymer prepared in Example 4 via a nucleophilic substitution reaction to graft sodium propanesulfate functional groups on the 2, 2′-biphenol unit and the isatin unit of the polymer, followed by an acidification reaction to convert sodium propanesulfate functional groups on the polymer to propanesulfonic acid functional groups to form the sulfonated non-fluorinated ether-free proton-conducting polymer PI2BPPT-SO₃H. Several PI2BPPT-SO₃H polymers were synthesized by varying the molar ratios of 2,2′-biphenol to p-terphenyl, such as 15:85 (abbreviated as PI2BPPT-SO₃H-15), 50:50 (abbreviated as PI2BPPT-SO₃H-50), 75:25 (abbreviated as PI2BPPT-SO₃H-75), and 100:0 (abbreviated as PI2BPPT-SO₃H-100).

As an example, PI2BPPT-SO₃H-50 was synthesized from PI2BPPT-50. To a 400 ml glass bottle, PI2BPPT-50 (10 g) was dissolved in DMSO (160 ml). Potassium carbonate (10 g) and sodium bromopropanesulfate (15 g) were added to the solution. The solution was stirred for 24 h at 70° C. The resultant viscous solution was cooled down and poured into acetone slowly. The resulting polymer PI2BPPT-SO₃Na-50 was filtered and soaked in 1 M HCl at 80° C. for 24 to convert PI2BPPT-SO₃Na-50 to the sulfonated PI2BPPT-SO₃H-50 proton-conducting polymer. The PI2BPPT-SO₃H-50 proton-conducting polymer was filtered and washed by water followed by drying at 100° C. under vacuum. The yield of PI2BPPT-SO₃H-50 proton-conducting polymer was 94%.

### Example 6: Preparation and Performance of PI2BPPT-30/PI2BPPT-SO₃H-30 Blend Proton Exchange Membrane

A PI2BPPT-30/PI2BPPT-SO₃H-30 blend proton exchange membrane was prepared by dissolving PI2BPPT-30 free radical scavenging polymer and PI2BPPT-SO₃H-30 proton-conductive polymer in DMSO solvent to form a 15 wt % PI2BPPT-30/PI2BPPT-SO₃H-30 blend polymer solution and casting the solution on a glass plate with a knife gap of 20 mil. After drying at 60° C. overnight, the membrane was detached and further dried in vacuum oven at 100° C. for 2 days to form PI2BPPT-30/PI2BPPT-SO₃H-30 blend proton exchange membrane. The in-plane proton conductivity of the PI2BPPT-30/PI2BPPT-SO₃H-30 blend proton exchange membrane was 141 mS/cm at room temperature, and the membrane showed stable performance without change in proton conductivity after 2500 h of soaking in 0.1 M HCl aqueous solution at 80° C., demonstrating the stability of the PI2BPPT-30/PI2BPPT-SO₃H-30 blend proton exchange membrane comprising PI2BPPT-30 free radical scavenging polymer. As a comparison, Nafion® NR212 commercial membrane showed in-plane proton conductivity of 88.5 mS/cm at room temperature, and the membrane showed about 11% proton conductivity decrease after 2500 h of soaking in 0.1 M HCl aqueous solution at 80° C.,

### Example 7: Synthesis of Poly(Isatin-1,1′-Bi-2-Naphthol-p-Terphenyl) Free Radical Scavenging Polymer Having Phenolic Hydroxyl Functional Groups (Abbreviated as PI1NPT)

A poly(isatin-1,1′-bi-2-naphthol-p-terphenyl) free radical scavenging polymer having phenolic hydroxyl functional groups (abbreviated as PI1NPT) was synthesized via a super acid catalyzed polyhydroxyalkylation reaction of three monomers, p-terphenyl, isatin, and 1,1′-bi-2-naphthol. The three monomers, p-terphenyl (9.79 g, 42.5 mmol), 1,1′-bi-2-naphthol (2.15 g, 7.5 mmol) and isatin (7.36 g, 50 mmol) were charged to a 500 mL three necked flask equipped with an overhead mechanical stirrer. Anhydrous methylene chloride (50 ml) was added to the flash and stirred for 5 min to form a suspension. The flask was then immersed in an ice bath to keep the reaction at low temperature. A mixture of trifluoromethanesulfonic acid (50 mL) and trifluoroacetic acid (25 mL) was added dropwise to the flask. Thereafter, the reaction continued for 4 h. The resulting viscous, dark blue solution was poured slowly into water. The solid was shredded into powders by a blender, filtered, washed with water, and immersed in water overnight. The polymer was filtered and washed thoroughly by water followed by drying at 60° C. under vacuum. The yield of the precursor PI1NPT polymer was 99%.

### Example 8: Synthesis of Sulfonated Poly(Isatin-1,1′-Bi-2-Naphthol-p-Terphenyl) Proton-Conductive Polymer (Abbreviated as PI1NPT-SO₃H)

A sulfonated poly(isatin-1,1′-bi-2-naphthol-p-terphenyl) proton-conductive polymer (abbreviated as PI1NPT-SO₃H) was synthesized from PI1NPT polymer as described in Example 7. To a 400 ml glass bottle, PI1NPT polymer (10 g) was dissolved in DMAc (56.7 g) to form a 15 wt % solution. 1,3-propanesultone (5 g) was added quickly to the solution. The solution was stirred for 16 h at 60° C. The resultant viscous solution was poured slowly into water under stirring. The solid was filtered, washed with water, and immersed in 0.5 M K₂CO₃ overnight. The polymer was filtered and washed thoroughly by water followed by drying at 80° C. under vacuum. The yield of PI1NPT-SO₃H was 98%.

### Example 9: Preparation of PI1NPT/PI1NPT-SO₃H Blend Proton Exchange Membrane

A PI1NPT/PI1NPT-SO₃H blend proton exchange membrane was prepared by dissolving PI1NPT free radical scavenging polymer and PI1NPT-SO₃H proton-conductive polymer in DMSO solvent to form a 20 wt % PI1NPT/PI1NPT-SO₃H blend polymer solution and casting the solution on a glass plate with a knife gap of 22 mil. After drying at 60° C. overnight, the membrane was detached and further dried in vacuum oven at 100° C. for 2 days to form PI1NPT/PI1NPT-SO₃H blend proton exchange membrane.

### Example 10: Synthesis of Poly(p-Terphenyl-2,2′-Biphenol-1-3-Isatin-2,2,2-Trifluoroacetophenone-4-1) Free Radical Scavenging Polymer Having Phenolic Hydroxyl Functional Groups (Abbreviated as PTBIT)

A poly(p-terphenyl-2,2′-biphenol-1-3-isatin-2,2,2-trifluoroacetophenone-4-1) free radical scavenging polymer having phenolic hydroxyl functional groups (abbreviated as PTBIT) was synthesized via a super acid catalyzed polyhydroxyalkylation reaction of four monomers, p-terphenyl, 2,2′-biphenol, isatin, and 2,2,2-trifluoroacetophenone. The molar ratio of 2,2′-biphenol: p-terphenyl: isatin: 2,2,2-trifluoroacetophenone is 0.75:0.25:0.8:0.2.

p-Terphenyl (2.88 g, 12.5 mmol) and 2, 2′-biphenol (7.01 g, 37.5 mmol) were charged to a 500 mL three necked flask equipped with an overhead mechanical stirrer. Anhydrous methylene chloride (50 ml) was added to the flash and stirred for 5 min to form a suspension. The flask was then immersed in an ice bath to keep the suspension at low temperature. A mixture of trifluoromethanesulfonic acid (50 mL), trifluoroacetic acid (25 mL), isatin (5.89 g, 40 mmol), and 2,2,2-trifluoroacetophenone (1.74 g, 10 mmol) was added to the flask dropwise. Thereafter, the reaction was continued for 14 h. The resulting viscous solution was poured slowly into a mixture of water and methanol under stirring. The solid was shredded into powders by a blender, filtered, washed with water, and immersed in 0.5 M K₂CO₃ overnight to remove the acids completely. The polymer was filtered and washed thoroughly with methanol followed by drying at 80° C. under vacuum. The yield of the poly(p-terphenyl-2,2′-biphenol-1-3-isatin-2,2,2-trifluoroacetophenone-4-1) (abbreviated as PTBIT) precursor polymer was 96%.

### Example 11: Synthesis of Sulfonated Poly(p-Terphenyl-2,2′-Biphenol-1-3-Isatin-2,2,2-Trifluoroacetophenone-4-1) Proton-Conductive Polymer (Abbreviated as PTBIT-SO₃H)

Sulfonated poly(p-terphenyl-2,2′-biphenol-1-3-isatin-2,2,2-trifluoroacetophenone-4-1) proton-conducting polymer (abbreviated as PTBIT-SO₃H) was synthesized from PTBIT polymer as described in Example 10 via a nucleophilic substitution reaction to graft sodium propanesulfate functional groups on the 2, 2′-biphenol unit and the isatin unit of the polymer, and finally an acidification reaction to convert sodium propanesulfate functional groups on the polymer to propanesulfonic acid functional groups to form the sulfonated ether-free proton-conducting polymer PTBIT-SO₃H. To a 400 ml glass bottle, PTBIT polymer (10 g) was dissolved in DMSO (160 ml). Potassium carbonate and sodium bromopropanesulfate were added to the solution. The solution was stirred for 24 h at 70° C. The resultant viscous solution was cooled down and poured into acetone slowly. The resulting polymer PTBIT-SO₃Na was filtered and soaked in IM HCl at 80° C. for 24 to convert PTBIT-SO₃Na to the sulfonated PTBIT-SO₃H proton-conducting polymer. The PTBIT-SO₃H proton-conducting polymer was filtered and washed by water followed by drying at 100° C. under vacuum.

### Example 12: Preparation of PTBIT/PTBIT-SO₃H Blend Proton Exchange Membrane

A PTBIT/PTBIT-SO₃H blend proton exchange membrane was prepared by dissolving PTBIT free radical scavenging polymer and PTBIT-SO₃H proton-conductive polymer in DMSO solvent to form a 15 wt % PTBIT/PTBIT-SO₃H blend polymer solution and casting the solution on a glass plate with a knife gap of 22 mil. After drying at 60° C. overnight, the membrane was detached and further dried in vacuum oven at 100° C. for 2 days to form PTBIT/PTBIT-SO₃H blend proton exchange membrane.

### Example 13. Preparation of a Membrane Electrode Assembly (MEA) Comprising PI2BPPT-75/PI2BPPT-SO₃H-75 Proton-Exchange Membrane for Water Electrolysis

A MEA comprising PI2BPPT-75/PI2BPPT-SO₃H-75 proton-exchange membrane was prepared by a catalyst coated on membrane (CCM) method using IrO₂ as an oxygen evolution reaction (OER) catalyst for the anode and Pt/C as a hydrogen evolution reaction (HER) catalyst for the cathode. Catalyst inks for spray coating were prepared by mixing the catalysts and PI2BPPT-SO₃H-75 proton-conducting polymer in DI water and isopropanol. The mixture was finely dispersed using an ultrasonication bath. PI2BPPT-SO₃H-75 proton-conducting polymer contents in the anode and the cathode were controlled to about 10 wt % in the total content of the catalyst and PI2BPPT-SO₃H-75 proton-conducting polymer. The Pt/C ink was spray coated onto one side of the membrane. The Pt loading was about 0.3 mg/cm². IrO₂ ink was spray coated onto the other side of the membrane. IrO₂ loading was about 2.0 mg/cm².

### Specific Embodiments

While the following is described in conjunction with specific embodiments, it will be understood that this description is intended to illustrate and not limit the scope of the preceding 5 description and the appended claims.

A first embodiment of the invention is a proton exchange membrane comprising a blend of a proton-conductive polymer and a free radical scavenging polymer having phenolic hydroxyl functional groups. An embodiment of the invention is one, any or all of prior embodiments in this paragraph up through the first embodiment in this paragraph wherein the free radical scavenging polymer comprises a plurality of repeating units of formula (II)

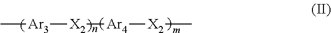

wherein Ar₃ is selected from the group consisting of

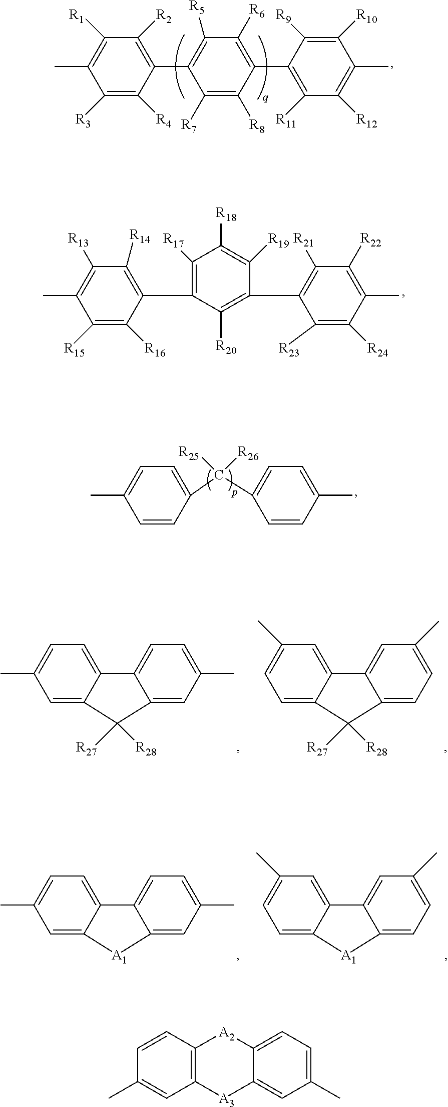

and mixtures thereof, wherein Ar₄ is selected from

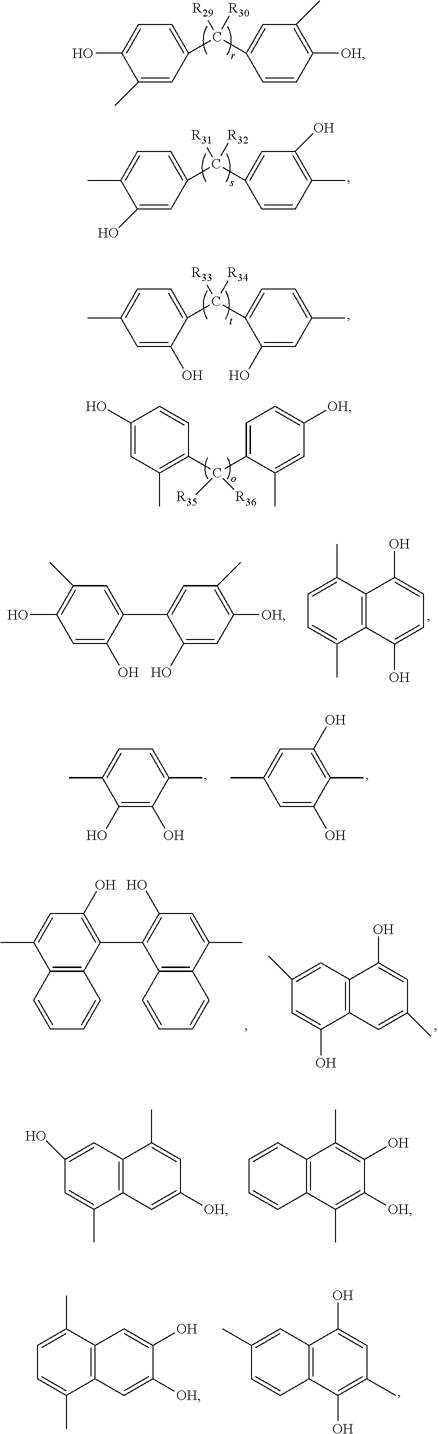

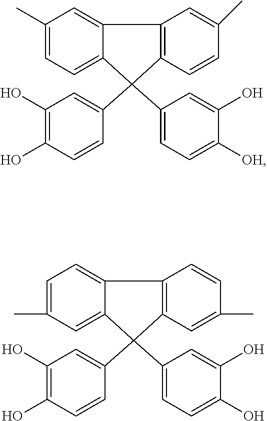

and mixtures thereof, wherein X₂ is selected from

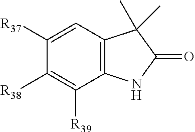

or a mixture of

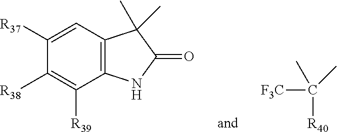

wherein R₁—R₃₆ are each independently hydrogen, a halogen, an alkyl group, an alkenyl group, an alkynyl group, or an aryl group, and wherein the alkyl group, the alkenyl group, the alkynyl group, or the aryl group is optionally substituted with a halogen; wherein R₃₇—R₄₀ are each independently hydrogen, an alkyl group, an alkenyl group, an alkynyl group, or an aryl group, and wherein the alkyl group, the alkenyl group, the alkynyl group or the aryl group is optionally substituted with a halogen; wherein the halogen is F, Cl, Br, or I; wherein A₁, A₂, and A₃ are each independently O, S, or NH; wherein m is an integer from 5 to 5000; wherein n is an integer from 0 to 5000; wherein a molar ratio of n/m is in a range of 01 to 201; wherein p is 1, 2, 3, or 4; wherein q is 0, 1, 2, or 3; and wherein r, s, t, and o are independently 0, 1, 2, or 3. An embodiment of the invention is one, any or all of prior embodiments in this paragraph up through the first embodiment in this paragraph wherein a weight ratio of the proton-conductive polymer to the free radical scavenging polymer is in a range of 1001 to 12. An embodiment of the invention is one, any or all of prior embodiments in this paragraph up through the first embodiment in this paragraph wherein a weight ratio of the proton-conductive polymer to the free radical scavenging polymer is in a range of 201 to 11. An embodiment of the invention is one, any or all of prior embodiments in this paragraph up through the first embodiment in this paragraph wherein a weight ratio of the proton-conductive polymer to the free radical scavenging polymer is in a range of 101 to 21. An embodiment of the invention is one, any or all of prior embodiments in this paragraph up through the first embodiment in this paragraph wherein Ar₃ is selected from the group consisting of

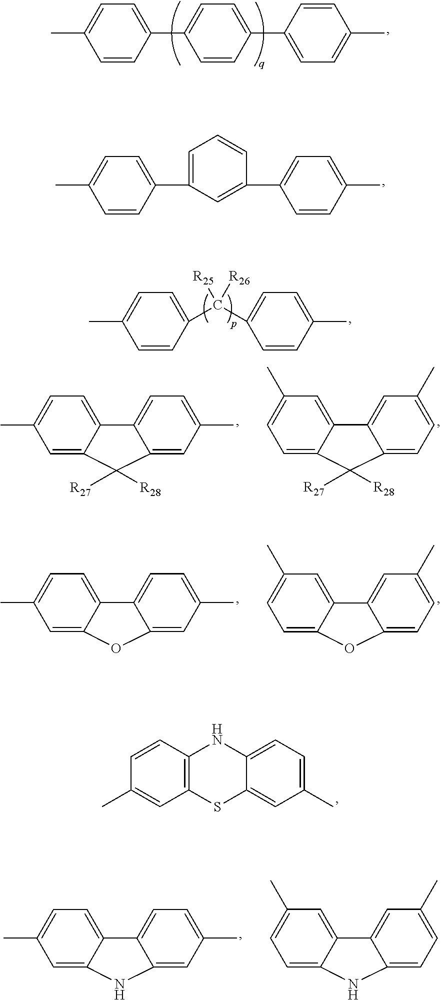

and mixtures thereof,
wherein R₂₅, R₂₆, R₂₇, and R₂₈ are each independently —H or —CH₃; wherein p is 1 or 2; and wherein q is 0 or 1. An embodiment of the invention is one, any or all of prior embodiments in this paragraph up through the first embodiment in this paragraph wherein Ar₄ is selected from the group consisting of

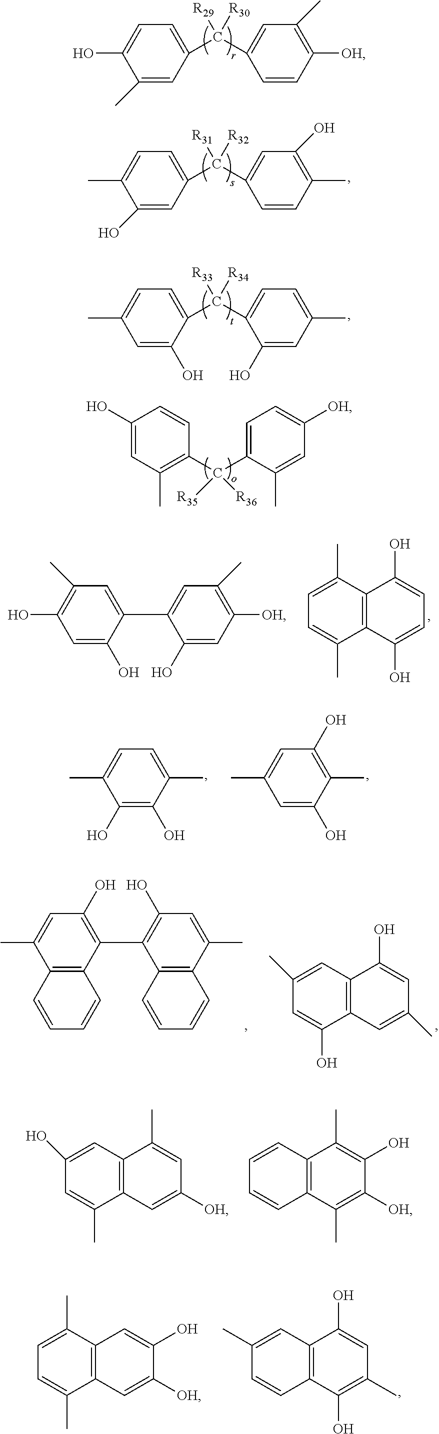

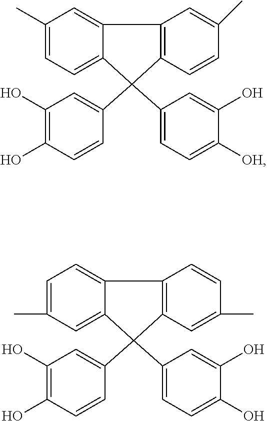

and mixtures thereof; wherein R₂₉, R₃₀, R₃₁, R₃₂, R₃₃, R₃₄, R₃₅, and R₃₆ are each independently —CH₃ or —CF₃; and wherein r, s, t, and o are each independently 0 or 1. An embodiment of the invention is one, any or all of prior embodiments in this paragraph up through the first embodiment in this paragraph wherein X₂ is

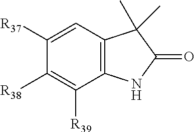

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂. An embodiment of the invention is one, any or all of prior embodiments in this paragraph up through the first embodiment in this paragraph wherein X₂ is a mixture of

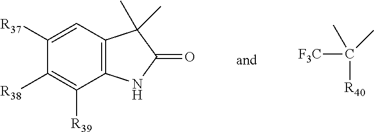

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and wherein R₄₀ is —CH₃, —CH₂CH₃, or —C₆H₅. An embodiment of the invention is one, any or all of prior embodiments in this paragraph up through the first embodiment in this paragraph wherein the proton-conductive polymer is selected from a fluorinated proton-conductive polymer, a non-fluorinated proton-conductive polymer, or a combination thereof. An embodiment of the invention is one, any or all of prior embodiments in this paragraph up through the first embodiment in this paragraph wherein the non-fluorinated proton-conductive polymer comprises a plurality of repeating units of formula (I)

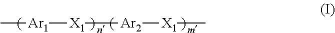

wherein one or more of Ar₁, Ar₂, and X₁ comprises an acid functional group, wherein the acid functional group comprises —SO₃⁻Z⁺, —COO⁻Z⁺, or —PO₃H⁻Z⁺, and wherein Z⁺ is H⁺, a metal cation, a quaternary ammonium cation, or mixtures thereof; wherein Ar₁ is selected from the group consisting of

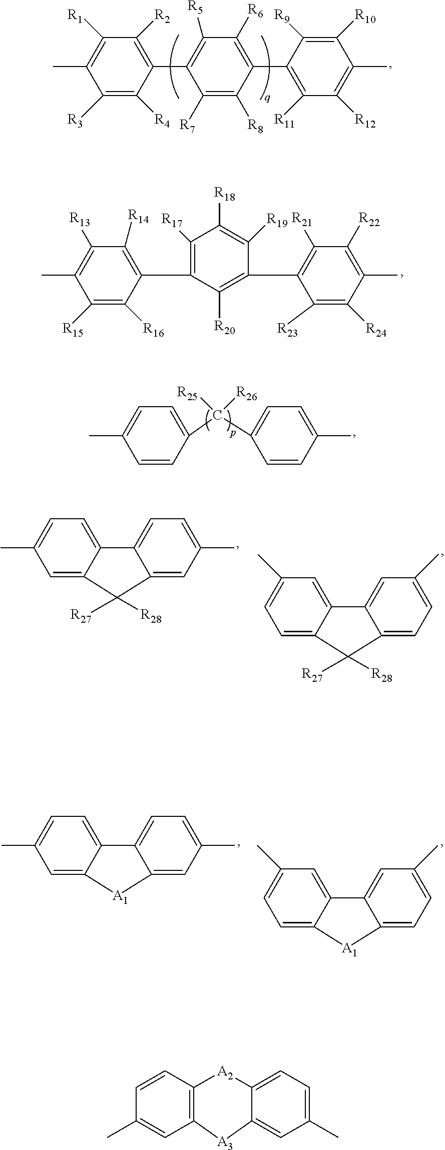

and mixtures thereof; wherein Ar₂ is selected from the group consisting of

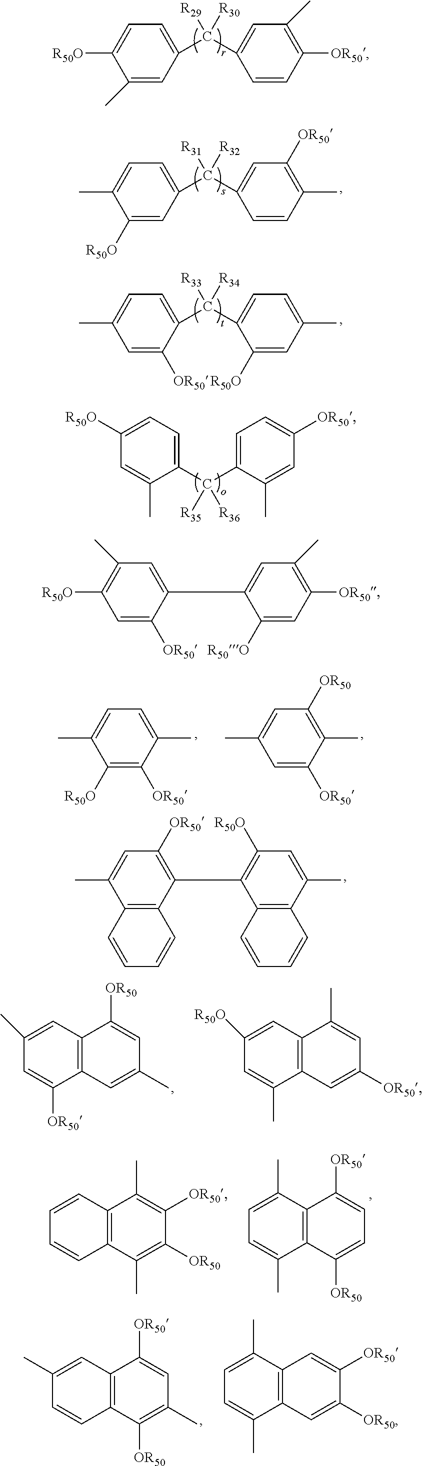

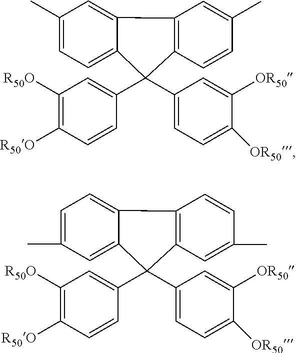

and mixtures thereof; and wherein X₁ is selected from the group consisting of

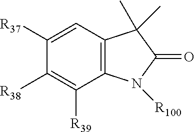

or a mixture of

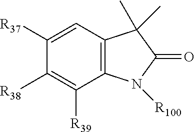

one or more of

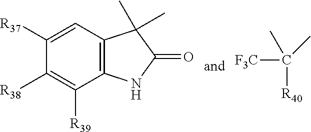

wherein R₁—R₃₆ are each independently hydrogen, a halogen, an alkyl group, an alkenyl group, an alkynyl group, or an aryl group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₁⁺, —COO⁻Z₁⁺, or —PO₃H⁻Z₁⁺, and wherein Z₁⁺ is H⁺, a metal cation, a quaternary ammonium cation, or mixtures thereof; wherein R₃₇—R₃₉ are each independently hydrogen, a halogen, a nitro group, an alkyl group, an alkenyl group, an alkynyl group, an aryl group, or an alkoxy group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₂⁺, —COO⁻Z₂⁺, or —PO₃H⁻Z₂⁺, and wherein Z₂⁺ is H⁺, a metal cation, a quaternary ammonium cation, or mixtures thereof; wherein R₄₀ is an alkyl group, an alkenyl group, an alkynyl group, or an aryl group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₃⁺, —COO⁻Z₃⁺, or —PO₃H⁻Z₃⁺, and wherein Z₃⁺ is H, a metal cation, a quaternary ammonium cation, or mixtures thereof; wherein R₅₀, R₅₀′, R₅₀″, and R₅₀′″ are each independently hydrogen, a substituted alkyl group, a substituted alkenyl group, a substituted alkynyl group, or a substituted aryl group, and wherein the substituted alkyl group, the substituted alkenyl group, the substituted alkynyl group, or the substituted aryl group are substituted with an acid functional group or are substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof; with the proviso that one or more of R₅₀ and R₅₀ is not hydrogen, or one or more of R₅₀, R₅₀′, R₅₀″, and R₅₀′″ is not hydrogen; wherein R₁₀₀ is independently a substituted alkyl group, a substituted alkenyl group, a substituted alkynyl group, or a substituted aryl group, and wherein the substituted alkyl group, the substituted alkenyl group, the substituted alkynyl group, or the substituted aryl group is substituted with an acid functional group or is substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof; wherein the halogen is F, Cl, Br, or I; wherein A₁, A₂, and A₃ are each independently O, S, or N—R₂₀₀ and wherein R₂₀₀ is hydrogen, a substituted alkyl group, a substituted alkenyl group, a substituted alkynyl group, or a substituted aryl group, and wherein the substituted alkyl group, the substituted alkenyl group, the substituted alkynyl group, or the substituted aryl group is substituted with an acid functional group or is substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof; wherein p is 1, 2, 3, or 4; wherein q is 0, 1, 2, or 3; wherein r, s, t, and o are independently 0, 1, 2, 3, 4, 5, or 6; and wherein n′ is an integer from 0 to 5000; wherein m′ is an integer from 5 to 5000; and wherein a molar ratio of n′/m′ is in a range of 01 to 201.

An embodiment of the invention is one, any or all of prior embodiments in this paragraph up through the first embodiment in this paragraph wherein Ar₁ is selected from the group consisting of

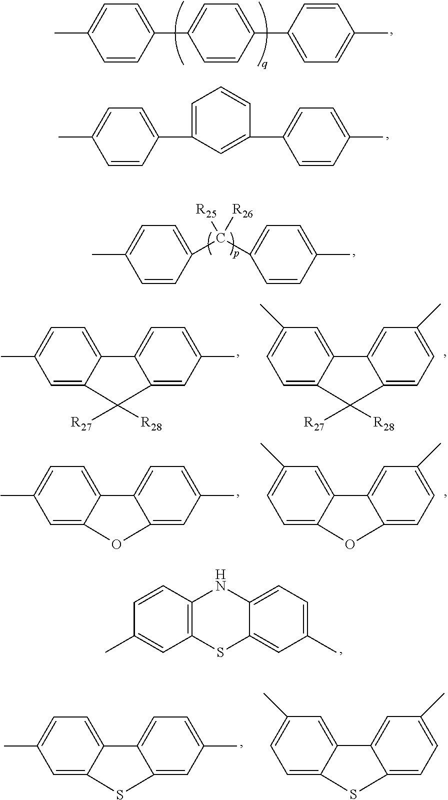

and mixtures thereof, wherein R₂₅, R₂₆, R₂₇, and R₂₈ are each independently —H or —CH₃; wherein p is 1 or 2; and wherein q is 0 or 1. An embodiment of the invention is one, any or all of prior embodiments in this paragraph up through the first embodiment in this paragraph wherein Ar₂ is selected from the group consisting of

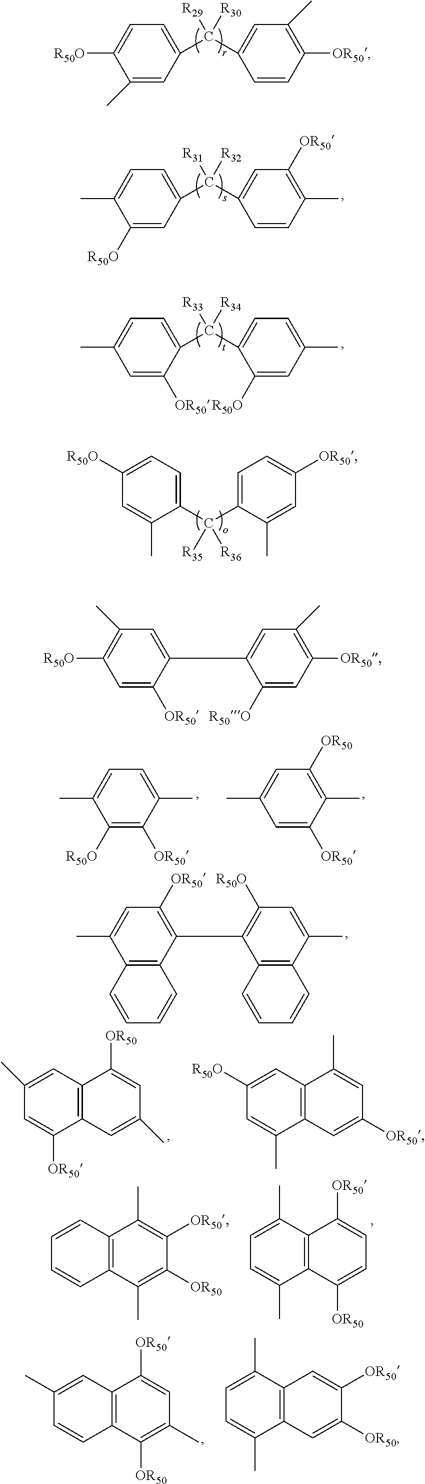

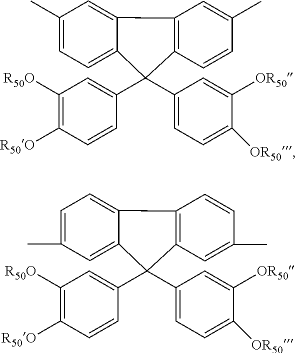

and mixtures thereof; wherein R₂₉—R₃₆ are each independently —CH₃ or —CF₃; wherein R₅₀, R₅₀′, R₅₀″, and R₅₀′″ are each independently hydrogen or —(CH₂)₃SO₃⁻Z₄⁺ and wherein Z₄⁺is H⁺, a metal cation, a quaternary ammonium cation, or mixtures thereof, with the proviso that one or more of R₅₀ and R₅₀ is not hydrogen, or one or more of R₅₀, R₅₀′, R₅₀″, and R₅₀′″ is not hydrogen; and wherein r, s, t, and o are each independently 0 or 1. An embodiment of the invention is one, any or all of prior embodiments in this paragraph up through the first embodiment in this paragraph wherein X₁ is

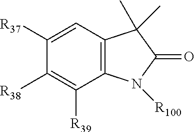

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and wherein R₁₀₀ is —(CH₂)₃SO₃⁻Z₄⁺ and wherein Z₄⁺is H⁺, a metal cation, a quaternary ammonium cation, or mixtures thereof. An embodiment of the invention is one, any or all of prior embodiments in this paragraph up through the first embodiment in this paragraph wherein X₁ is a mixture of

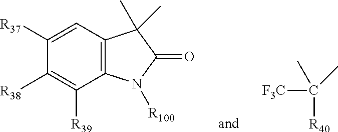

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; wherein R₄₀ is —CH₃, —CH₂CH₃, or —C₆H₅; and wherein R₁₀₀ is —(CH₂)₃SO₃⁻Z₄⁺ and wherein Z₄⁺is H⁺, a metal cation, a quaternary ammonium cation, or mixtures thereof. An embodiment of the invention is one, any or all of prior embodiments in this paragraph up through the first embodiment in this paragraph wherein X₁ is a mixture of

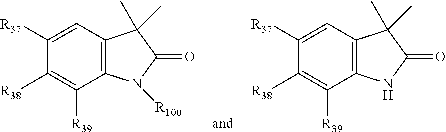

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and wherein R₁₀₀ is —(CH₂)₃SO₃⁻Z₄⁺ and wherein Z₄⁺is H⁺, a metal cation, a quaternary ammonium cation, or mixtures thereof. An embodiment of the invention is one, any or all of prior embodiments in this paragraph up through the first embodiment in this paragraph wherein X₁ is a mixture of

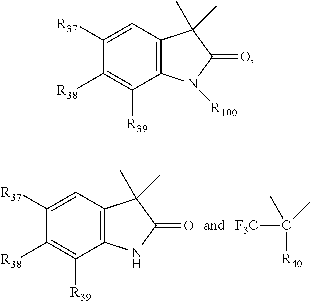

wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; wherein R₄₀ is —CH₃, —CH₂CH₃, or —C₆H₅; and wherein R₁₀₀ is —(CH₂)₃SO₃⁻Z₄⁺ and wherein Z₄⁺is H⁺, a metal cation, a quaternary ammonium cation, or mixtures thereof. An embodiment of the invention is one, any or all of prior embodiments in this paragraph up through the first embodiment in this paragraph wherein Ar₁ is selected from the group consisting of

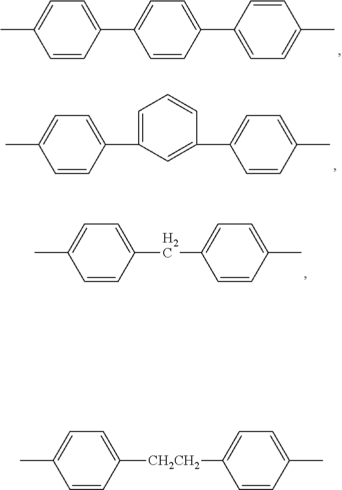

and mixtures thereof; or
wherein Ar₂ is selected from the group consisting of

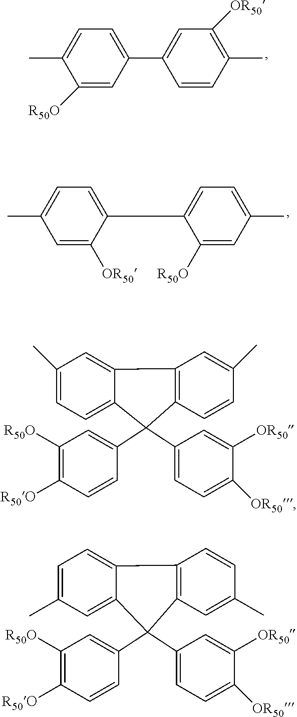

and mixtures thereof; wherein R₅₀, R₅₀′, R₅₀″, and R₅₀′″ are each independently hydrogen or —(CH₂)₃SO₃⁻Z₄⁺ and wherein Z₄⁺is H⁺, Na⁺, K⁺, NH₄⁺, or mixtures thereof, with the proviso that one or more of R₅₀ and R₅₀′ is not hydrogen, or one or more of R₅₀, R₅₀′, R₅₀″, and R₅₀′″ is not hydrogen; or both.

An embodiment of the invention is one, any or all of prior embodiments in this paragraph up through the first embodiment in this paragraph wherein X₁ is

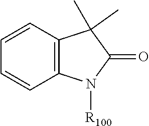

or a mixture of

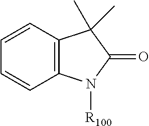

and one or more of

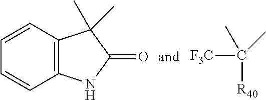

wherein R₁₀₀ is —(CH₂)₃SO₃⁻Z₄⁺ and wherein Z₄⁺is H⁺, Na⁺, K⁺, NH₄⁺, or mixtures thereof; and wherein R₄₀ is —CH₃, —CH₂CH₃, or —C₆H₅.

A second embodiment of the invention is a membrane electrode assembly comprising a proton exchange membrane comprising a blend of a proton-conductive polymer and a free radical scavenging polymer having phenolic hydroxyl functional groups; an anode comprising an anode catalyst on a first surface of the proton exchange membrane; and a cathode comprising a cathode catalyst on a second surface of the proton exchange membrane; and optionally, an anode gas diffusion layer adjacent to the anode; and optionally, a cathode gas diffusion layer adjacent to the cathode.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A proton exchange membrane comprising:
a blend of a proton-conductive polymer and a free radical scavenging polymer having phenolic hydroxyl functional groups.

2. The proton exchange membrane of claim 1 wherein the free radical scavenging polymer comprises a plurality of repeating units of formula (II) 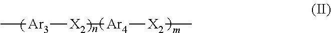
wherein Ar₃ is selected from the group consisting of: 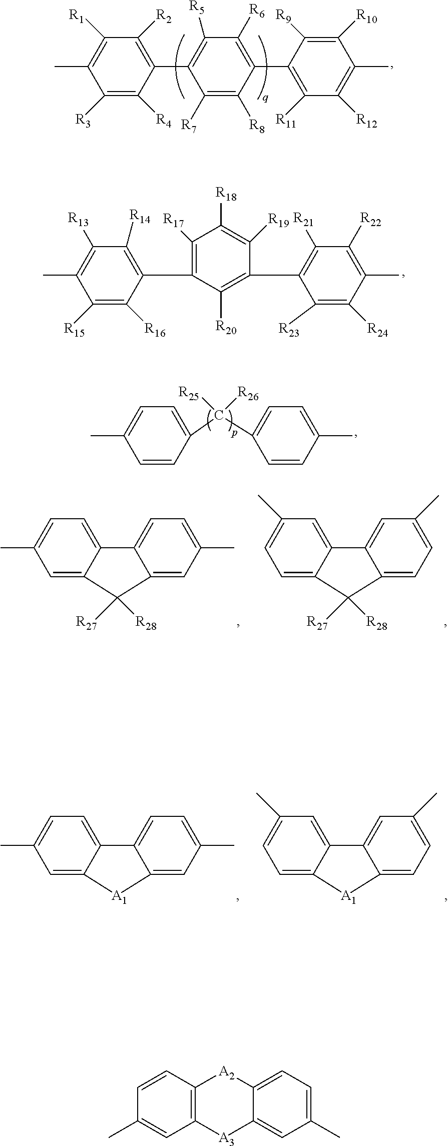
and mixtures thereof;
wherein Ar₄ is selected from: 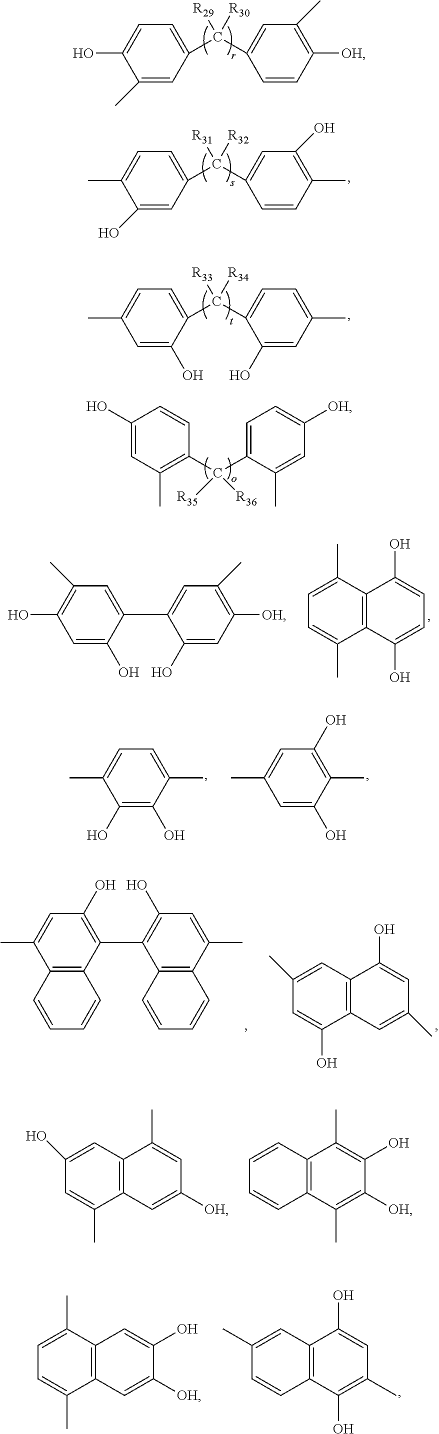 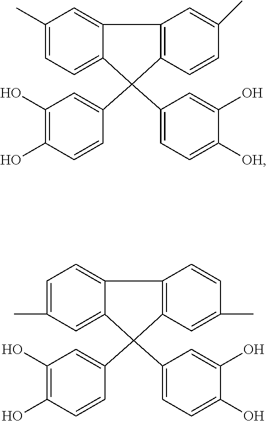
and mixtures thereof;
wherein X₂ is selected from: 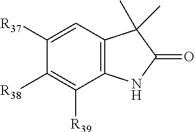
or a mixture of 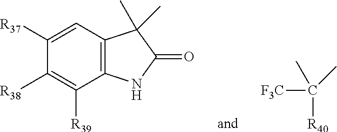
wherein R₁—R₃₆ are each independently hydrogen, a halogen, an alkyl group, an alkenyl group, an alkynyl group, or an aryl group, and wherein the alkyl group, the alkenyl group, the alkynyl group, or the aryl group is optionally substituted with a halogen;
wherein R₃₇—R₄₀ are each independently hydrogen, an alkyl group, an alkenyl group, an alkynyl group, or an aryl group, and wherein the alkyl group, the alkenyl group, the alkynyl group or the aryl group is optionally substituted with a halogen;
wherein the halogen is F, Cl, Br, or I;
wherein A₁, A₂, and A₃ are each independently O, S, or NH;
wherein m is an integer from 5 to 5000;
wherein n is an integer from 0 to 5000;
wherein a molar ratio of n/m is in a range of 0:1 to 20:1;
wherein p is 1, 2, 3, or 4;
wherein q is 0, 1, 2, or 3; and
wherein r, s, t, and o are independently 0, 1, 2, or 3.

3. The proton exchange membrane of claim 1 wherein a weight ratio of the proton-conductive polymer to the free radical scavenging polymer is in a range of 100:1 to 1:2.

4. The proton exchange membrane of claim 1 wherein a weight ratio of the proton-conductive polymer to the free radical scavenging polymer is in a range of 20:1 to 1:1.

5. The proton exchange membrane of claim 1 wherein a weight ratio of the proton-conductive polymer to the free radical scavenging polymer is in a range of 10:1 to 2:1.

6. The proton exchange membrane of claim 1 wherein Ar₃ is selected from the group consisting of: 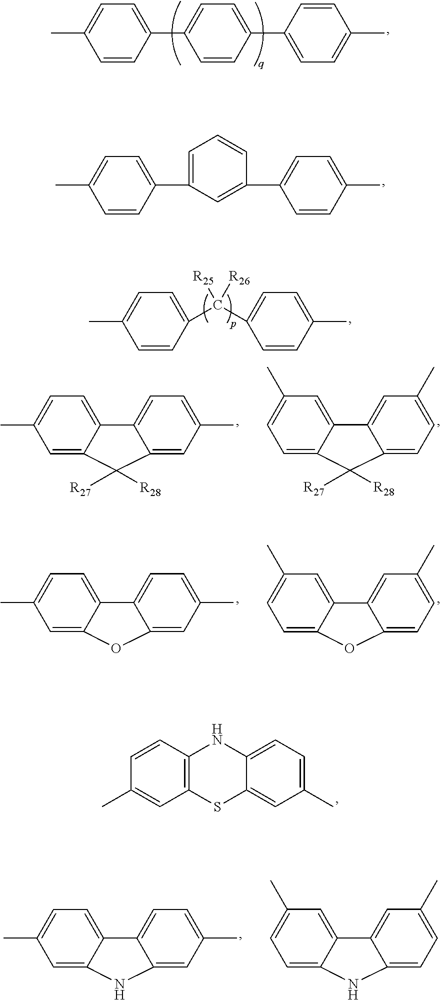
and mixtures thereof,
wherein R₂₅, R₂₆, R₂₇, and R₂₈ are each independently —H or —CH₃;
wherein p is 1 or 2; and
wherein q is 0 or 1.

7. The proton exchange membrane of claim 1 wherein Ara is selected from the group consisting of: 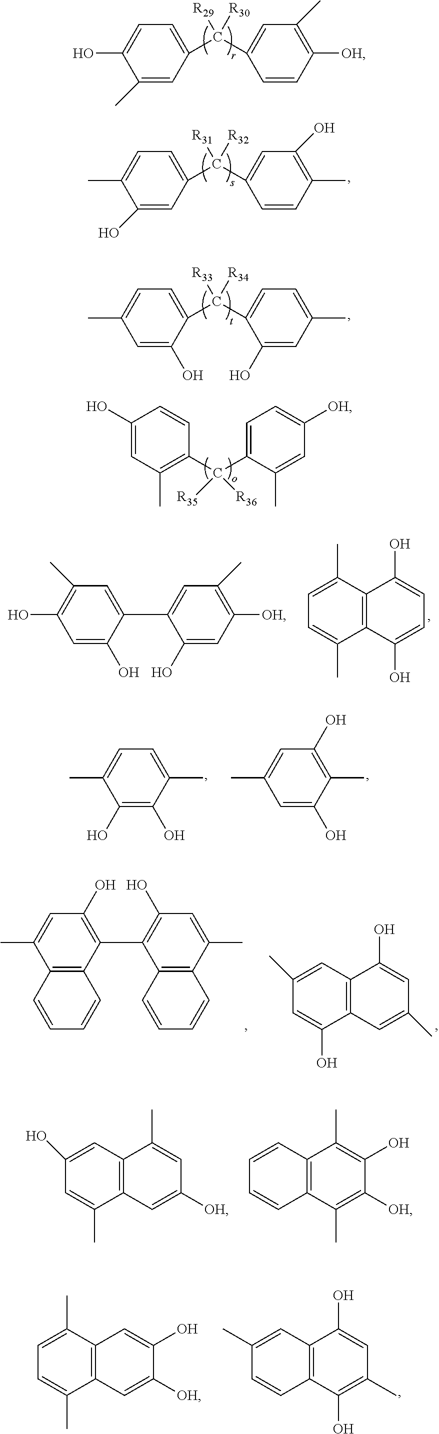 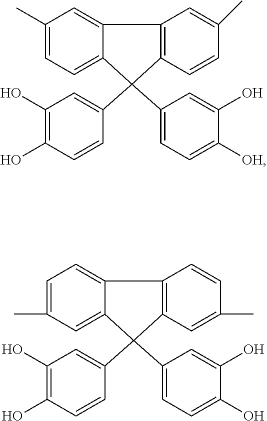
and mixtures thereof;
wherein R₂₉, R₃₀, R₃₁, R₃₂, R₃₃, R₃₄, R₃₅, and R₃₆ are each independently —CH₃ or —CF₃; and
wherein r, s, t, and o are each independently 0 or 1.

8. The proton exchange membrane of claim 1 wherein X, is 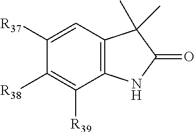
wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂.

9. The proton exchange membrane of claim 1 wherein X₂ is a mixture of 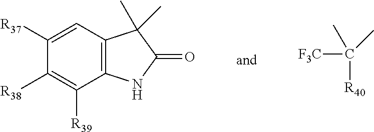
wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and
wherein R₄₀ is —CH₃, —CH₂CH₃, or —C₆H₅.

10. The proton exchange membrane of claim 1 wherein the proton-conductive polymer is selected from a fluorinated proton-conductive polymer, a non-fluorinated proton-conductive polymer, or a combination thereof.

11. The proton exchange membrane of claim 10 wherein the non-fluorinated proton-conductive polymer comprises a plurality of repeating units of formula (I) 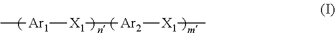
wherein one or more of Ar₁, Ar₂, and X₁ comprises an acid functional group, wherein the acid functional group comprises —SO₃⁻Z⁺, —COO⁻Z⁺, or —PO₃H⁻Z⁺, and wherein Z⁺ is H⁺, a metal cation, a quaternary ammonium cation, or mixtures thereof;
wherein Ar₁ is selected from the group consisting of: 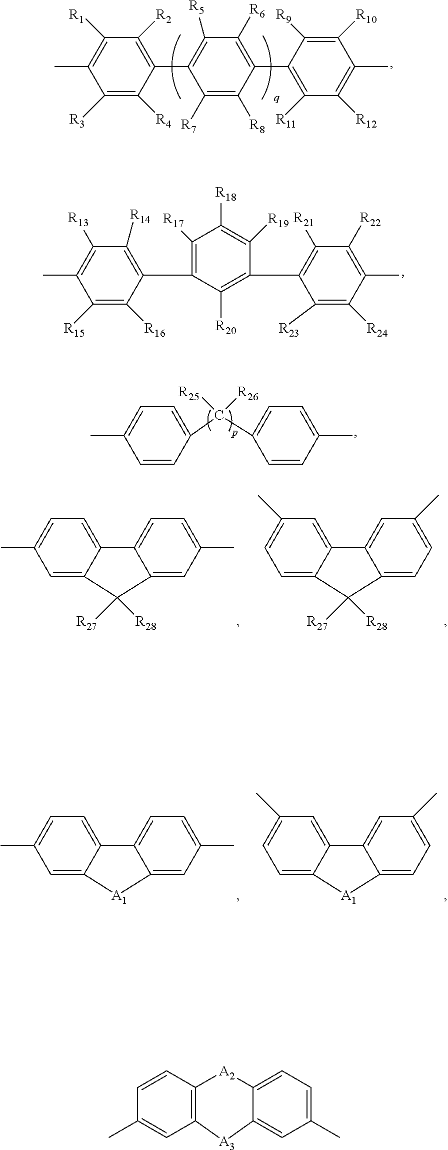
and mixtures thereof;
wherein Ar₂ is selected from the group consisting of: 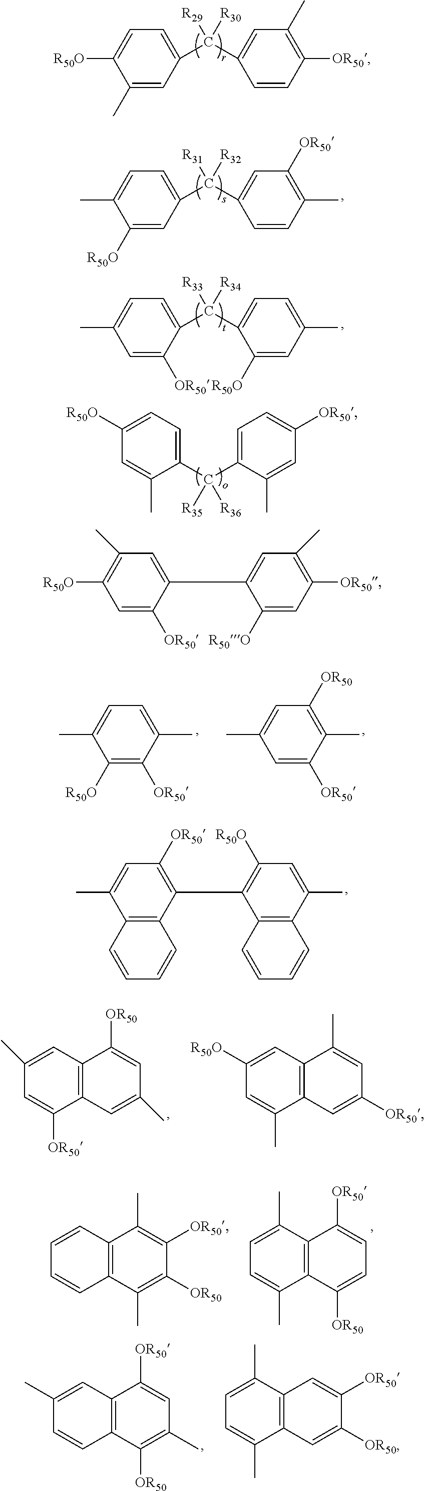 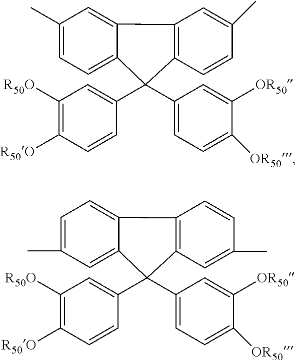
and mixtures thereof; and
wherein X₁ is selected from the group consisting of: 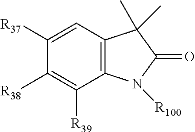
or a mixture of 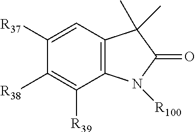
and
one or more of: 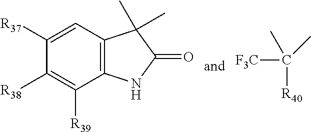
wherein R₁—R₃₆ are each independently hydrogen, a halogen, an alkyl group, an alkenyl group, an alkynyl group, or an aryl group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₁⁺, —COO⁻Z₁⁺, or —PO₃H⁻Z₁⁺, and wherein Z₁⁺ is H⁺, a metal cation, a quaternary ammonium cation, or mixtures thereof;
wherein R₃₇—R₃₉ are each independently hydrogen, a halogen, a nitro group, an alkyl group, an alkenyl group, an alkynyl group, an aryl group, or an alkoxy group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₂⁺, —COO⁻Z₂⁺, or −PO₃H⁻Z₂⁺, and wherein Z₂⁺ is H⁺, a metal cation, a quaternary ammonium cation, or mixtures thereof;
wherein R₄₀ is an alkyl group, an alkenyl group, an alkynyl group, or an aryl group, and wherein the alkyl group, the alkenyl group, the alkynyl group, or the aryl group is optionally substituted with a halogen, an acid functional group, or the halogen and the acid functional group, and wherein the acid functional group is —SO₃⁻Z₃⁺, —COO⁻Z₃⁺, or —PO₃H⁻Z₃⁺, and wherein Z₃⁺ is H⁺, a metal cation, a quaternary ammonium cation, or mixtures thereof;
wherein R₅₀, R₅₀^{′}, R₅₀″, and R₅₀′″ are each independently hydrogen, a substituted alkyl group, a substituted alkenyl group, a substituted alkynyl group, or a substituted aryl group, and wherein the substituted alkyl group, the substituted alkenyl group, the substituted alkynyl group, or the substituted aryl group are substituted with an acid functional group or are substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof; with the proviso that one or more of R₅₀ and R₅₀ is not hydrogen, or one or more of R₅₀, R₅₀^{′}, R₅₀^{″}, and R₅₀′″ is not hydrogen;
wherein R₁₀₀ is independently a substituted alkyl group, a substituted alkenyl group, a substituted alkynyl group, or a substituted aryl group, and wherein the substituted alkyl group, the substituted alkenyl group, the substituted alkynyl group, or the substituted aryl group is substituted with an acid functional group or is substituted with a halogen and the acid functional group; wherein the acid functional group is —SO₃⁻Z₄⁺, or —PO₃H⁻Z₄⁺, and wherein Z₄⁺ is H⁺, a metal cation, a quaternary ammonium cation, or mixtures thereof;
wherein the halogen is F, Cl, Br, or I;
wherein A₁, A₂, and A₃ are each independently O, S, or N—R₂₀₀ and wherein R₂₀₀ is hydrogen, a substituted alkyl group, a substituted alkenyl group, a substituted alkynyl group, or a substituted aryl group, and wherein the substituted alkyl group, the substituted alkenyl group, the substituted alkynyl group, or the substituted aryl group is substituted with an acid functional group or is substituted with a halogen and the acid functional group; wherein the acid functional group is —SO₃⁻Z₄⁺, —COO⁻Z₄⁺, or —PO₃H⁻Z₄⁺, and wherein Z₄⁺ is H⁺, a metal cation, a quaternary ammonium cation, or mixtures thereof;
wherein p is 1, 2, 3, or 4;
wherein q is 0, 1, 2, or 3;
wherein r, s, t, and o are independently 0, 1, 2, 3, 4, 5, or 6; and
wherein n′ is an integer from 0 to 5000;
wherein m′ is an integer from 5 to 5000; and
wherein a molar ratio of n′/m′ is in a range of 0:1 to 20:1.

12. The proton exchange membrane of claim 11 wherein Ar₁ is selected from the group consisting of 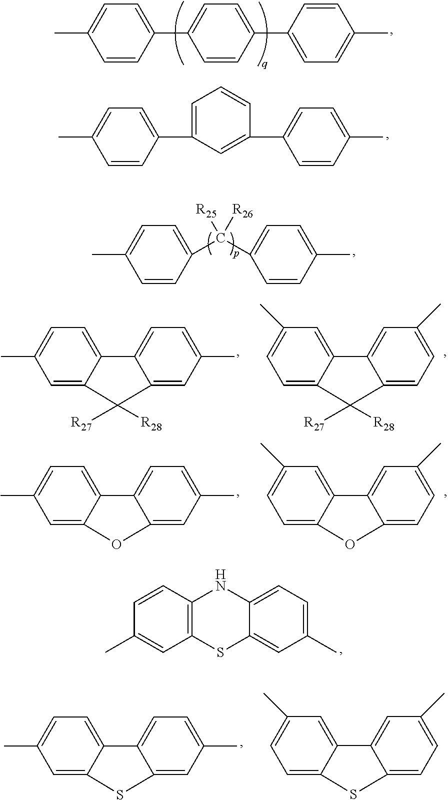
and mixtures thereof,
wherein R₂₅, R₂₆, R₂₇, and R₂₈ are each independently —H or —CH₃;
wherein p is 1 or 2; and
wherein q is 0 or 1.

13. The proton exchange membrane of claim 11 wherein Ar₂ is selected from the group consisting of 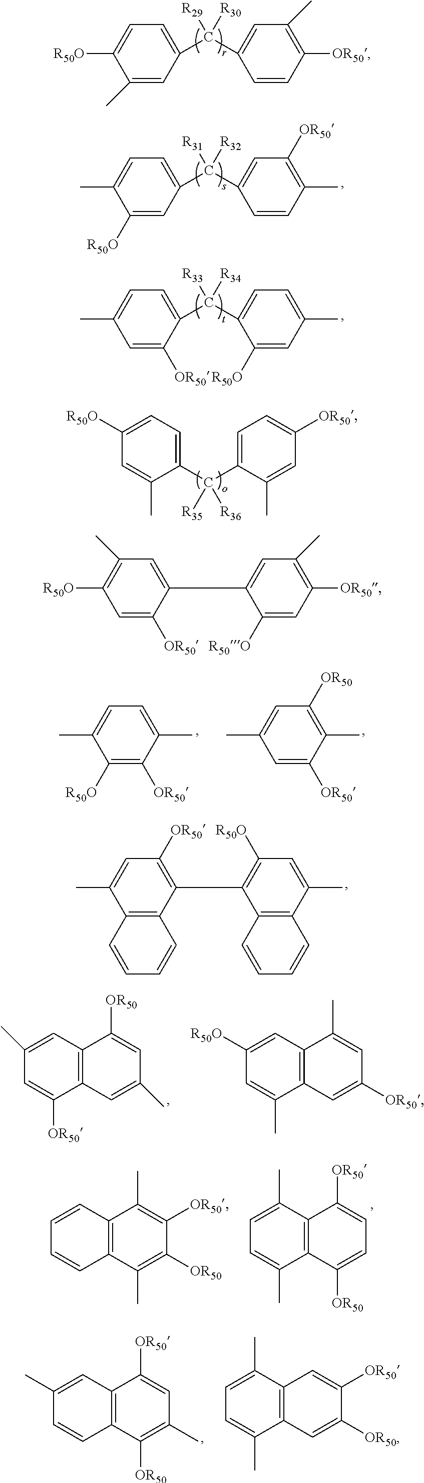 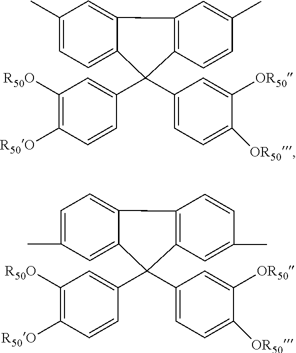
and mixtures thereof;
wherein R₂₉—R₃₆ are each independently —CH₃ or —CF₃;
wherein R₅₀, R₅₀′, R₅₀″, and R₅₀′″ are each independently hydrogen or —(CH₂)₃SO₃Z₄⁺ and wherein Z₄⁺ is H⁺, a metal cation, a quaternary ammonium cation, or mixtures thereof, with the proviso that one or more of R₅₀ and R₅₀′ is not hydrogen, or one or more of R₅₀, R₅₀′, R₅₀″, and R₅₀′″ is not hydrogen; and
wherein r, s, t, and o are each independently 0 or 1.

14. The proton exchange membrane of claim 11 wherein X₁ is 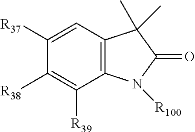
wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and
wherein R₁₀₀ is —(CH₂)₃SO₃⁻Z₄⁺ and wherein Z₄⁺is H⁺, a metal cation, a quaternary ammonium cation, or mixtures thereof.

15. The proton exchange membrane of claim 11 wherein X₁ is a mixture of 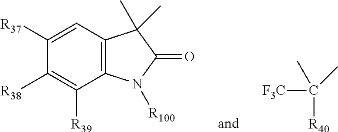
wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂;
wherein R₄₀ is —CH₃, —CH₂CH₃, or —C₆H₅; and
wherein R₁₀₀ is —(CH₂)₃SO₃⁻Z₄⁺ and wherein Z₄⁺is H⁺, a metal cation, a quaternary ammonium cation, or mixtures thereof.

16. The proton exchange membrane of claim 11 wherein X₁ is a mixture of 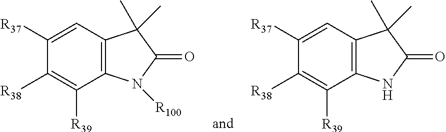
wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂; and
wherein R₁₀₀ is —(CH₂)₃SO₃⁻Z₄⁺ and wherein Z₄⁺is H⁺, a metal cation, a quaternary ammonium cation, or mixtures thereof.

17. The proton exchange membrane of claim 11 wherein X₁ is a mixture of 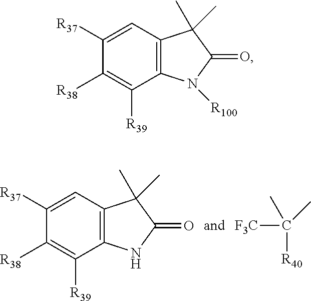
wherein R₃₇, R₃₈, and R₃₉ are each independently —H, —CH₃, —CH₂CH₃, —CH(CH₃)₂, —C(CH₃)₃, —CH₂—C₆H₅, or —CH₂—CH(CH₃)₂;
wherein R₄₀ is —CH₃, —CH₂CH₃, or —C₆H₅; and
wherein R₁₀₀ is —(CH₂)₃SO₃⁻Z₄⁺ and wherein Z₄⁺is H⁺, a metal cation, a quaternary ammonium cation, or mixtures thereof.

18. The proton exchange membrane of claim 11 wherein Ar₁ is selected from the group consisting of 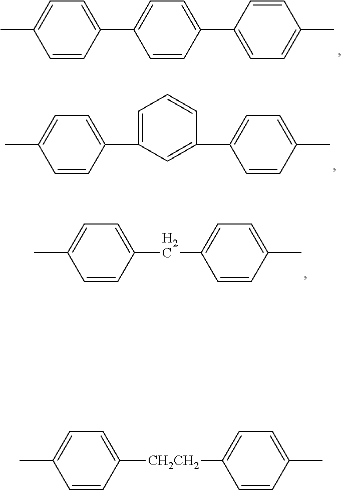
and mixtures thereof;
or
wherein Ar₂ is selected from the group consisting of: 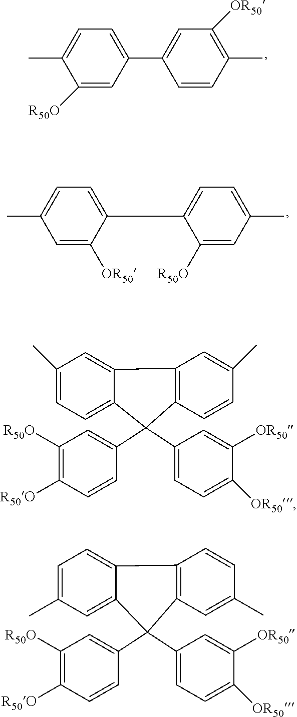
and mixtures thereof;
wherein R₅₀, R₅₀′, R₅₀″, and R₅₀′″ are each independently hydrogen or —(CH₂)₃SO₃⁻Z₄⁺ and wherein Z₄⁺ is H⁺, Na⁺, K⁺, NH₄⁺, or mixtures thereof, with the proviso that one or more of R₅₀ and R₅₀′ is not hydrogen, or one or more of R₅₀, R₅₀′, R₅₀″, and R₅₀′″ is not hydrogen;
or both.

19. The proton exchange membrane of claim 11 wherein X₁ is 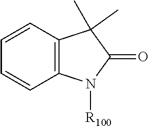
or a mixture of 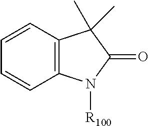
and one or more of: 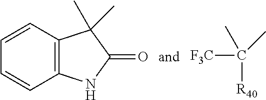
wherein R₁₀₀ is —(CH₂)₃SO₃⁻Z₄⁺ and wherein Z₄⁺is H⁺, Na⁺, K⁺, NH₄⁺, or mixtures thereof; and
wherein R₄₀ is —CH₃, —CH₂CH₃, or —C₆H₅.

20. A membrane electrode assembly comprising:
a proton exchange membrane comprising a blend of a proton-conductive polymer and a free radical scavenging polymer having phenolic hydroxyl functional groups;
an anode comprising an anode catalyst on a first surface of the proton exchange membrane; and
a cathode comprising a cathode catalyst on a second surface of the proton exchange membrane; and
optionally, an anode gas diffusion layer adjacent to the anode; and
optionally, a cathode gas diffusion layer adjacent to the cathode.
